(19) United States
(12) Patent Application Publication
(10) Pub. No.: US 2007/0110199 A1
(43) Pub. Date: May 17, 2007

(54) Receive equalizer with adaptive loops

(76) Inventors: Afshin Momtaz, Laguna Hills, CA (US); Chung-Jue Chen, Irvine, CA (US); Hong Chen, Irvine, CA (US); Vasudevan Parthasarathy, Irvine, CA (US); Rajesh Satapathy, Lake Forest, CA (US)

Correspondence Address: CHRISTIE, PARKER & HALE, LLP, PO BOX 7068, PASADENA, CA, 91109-7068, US

(21) Appl. No.: 11/292,610

(22) Filed: Dec. 2, 2005

Related U.S. Application Data
(60) Provisional application No. 60/737,292, filed on Nov. 15, 2005.

(51) Int. Cl. H04B 1/10; H04L 7/00

(52) U.S. Cl. 375/350; 375/355

(57) ABSTRACT

A communication receiver includes a decision feedback equalizer and clock and data recovery circuit. Various adaptation loops may control the operation of the decision feedback equalizer, the clock and data recovery circuit, a continuous time filter, a threshold adjust circuit, and an analog-to-digital clock that is used to generate soft decision data for some of the adaptation loops.

### TECHNICAL FIELD

This application relates to data communications and, more specifically, to equalization of received signals using adaptive loops.

### BACKGROUND

In a typical data communications system data is sent from a transmitter to a receiver over a communications media such as a wire or fiber optic cable. In general, the data is encoded in a manner that facilitates effective transmission over the media. For example, data may be encoded as a stream of binary data (e.g., symbols) that are transmitted through the media as a serial signal.

In general, serial communication systems only transmit data over the communication media. That is, the transmitters in communications systems may not transmit a separate clock signal with the data. Such a clock signal could be used by a receiver to efficiently recover data from the serial signal the receiver receives from the communication media.

When a clock signal is not transmitted, a receiver for a serial communication system may include a clock and data recovery circuit that generates a clock signal that is synchronized with the incoming data stream. For example, the clock and data recovery circuit may process the incoming data stream to generate a clock signal at a frequency that matches the frequency of the data stream. The clock is then used to sample or recover the individual data bits (e.g., “symbols”) from the incoming data stream.

In a typical high speed application, symbols in a data stream are distorted as they pass through the media. For example, bandwidth limitations inherent in the media tend to spread the transmitted pulses. As a specific example, in optical communication systems chromatic dispersion and polarization mode dispersion which result from variation of light propagation speed as a function of wavelength and propagation axes may cause symbol spread.

If the width of the spread pulse exceeds a symbol duration, overlap with neighboring pulses may occur, degrading the performance of the receiver. This phenomenon is called inter-symbol interference (“ISI”). In general, as the data rate or the distance between the transmitter and receiver increases, the bandwidth limitations of the media tend to cause more inter-symbol interference.

To compensate for such problems in received signals, conventional high speed receivers may include filters and/or equalizers that, for example, cancel some of the effects of inter-symbol interference or other distortion. Examples of such components include a decision feedback equalizer (“DFE”) and a feedforward equalizer (“FFE”).

Moreover, some applications use adaptive filters or equalizers that automatically adjust their characteristics in response to changes in the characteristics of the communications media. Typically, the adaptation process involves generating coefficients that control the characteristics of the filter or equalizer. To this end, a variety of algorithms have been developed for generating these coefficients.

Conventional receiver architectures may not provide optimum equalization of a received signal in many applications. For example, equalization algorithms may be implemented at various stages of the receive process. These equalization algorithms may not be entirely independent, however. As a result, the interaction of the equalization algorithms may degrade the performance of the equalization and, in some cases, lead to instability in the receiver.

These and other characteristics of conventional architectures may have a negative impact on the performance of a receiver. Accordingly, a need exists for an improved receiver architecture.

### SUMMARY

A system and/or method of equalizing signals for a system, substantially as shown in and/or described in connection with at least one of the figures, as set forth more completely in the claims.

### BRIEF DESCRIPTION OF THE DRAWINGS

These and other features, aspects and advantages of the present invention will be more fully understood when considered with respect to the following detailed description, appended claims and accompanying drawings, wherein:

FIG. 1 is a simplified block diagram of one embodiment of a data communication receiver constructed in accordance with the invention;

FIG. 2 is a simplified block diagram of one embodiment of a decision feedback equalizer and clock and data recovery circuit illustrating coefficients that may be used to control the characteristics of the equalizer and the phase of the clock and data recovery circuit;

FIG. 3 is a simplified block diagram of one embodiment of a delay lock loop and analog to digital converter circuit that may be used to generate digital soft decision data for one or more adaptation loops;

FIG. 4 is a flow chart of one embodiment of relative error operations that may be used in an adaptation loop to adjust the phase of a clock for an analog to digital converter;

FIG. 5 is a flow chart of one embodiment of threshold adjust operations that may be performed in accordance with the invention;

FIG. 6 is a simplified diagram illustrating one embodiment of a histogram that may be used in a threshold adjust loop;

FIG. 7 is a simplified diagram illustrating one embodiment of a tail interpretation from a histogram for a threshold adjust loop;

FIG. 8 is a flow chart of one embodiment of threshold adjust operations that may be performed in accordance with the invention;

FIG. 9 is a flow chart of one embodiment of search engine operations that may be performed in accordance with the invention;

FIG. 10, including FIGS. 10A and 10B, is a flow chart of one embodiment of search engine operations that may be performed in accordance with the invention;

FIG. 11 is a simplified diagram illustration loop nesting in accordance with the invention;

FIG. 12 is a simplified state diagram of one embodiment of loop operations performed in accordance with the invention; and

FIG. 13 is a simplified block diagram of one embodiment of an optical communication system.

In accordance with common practice the various features illustrated in the drawings may not be drawn to scale. Accordingly, the dimensions of the various features may be arbitrarily expanded or reduced for clarity. In addition, some of the drawings may be simplified for clarity. Thus, the drawings may not depict all of the components of a given apparatus or method. Finally, like reference numerals denote like features throughout the specification and figures.

### DETAILED DESCRIPTION

The invention is described below, with reference to detailed illustrative embodiments. It will be apparent that the invention may be embodied in a wide variety of forms, some of which may be quite different from those of the disclosed embodiments. Consequently, the specific structural and functional details disclosed herein are merely representative and do not limit the scope of the invention. For example, references to specific structures and processes in the disclosed embodiments should be understood to be but one example of structures and processes that may be used in these or other embodiments in accordance with the teachings provided herein. Also, references to “an” or “one” embodiment in this discussion are not necessarily to the same embodiment, and such references mean at least one.

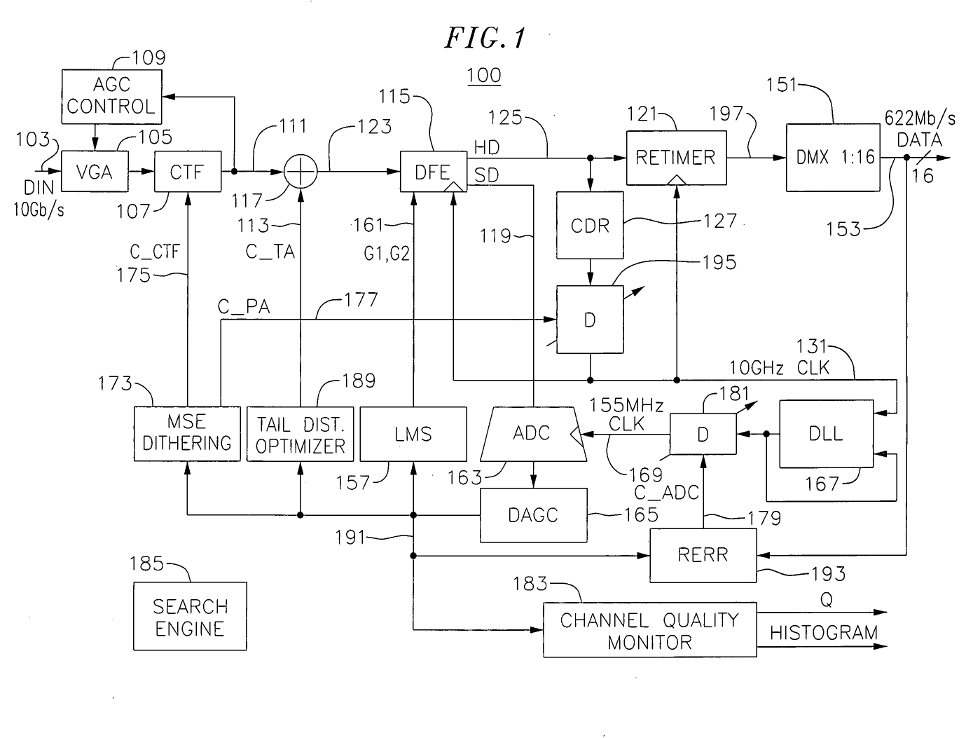

FIG. 1 is a simplified diagram of one embodiment of a communication receiver 100. The receiver employs several adaptation loops to extract a clock and data from a received signal. To avoid undesirable interactions between the loops, the loops may be implemented using different error criteria, different error algorithms and different bandwidths.

An automatic gain control loop adjusts the amplitude of the received signal. This loop is based, for example, on the RMS value of the input signal and is substantially independent of the other loops.

The receiver 100 employs an adjustable continuous time filter (“CTF”) and a decision feedback equalizer (“DFE”) to reduce errors in the data recovered from the received signal. Although both of these loops are based on square error criteria, different error algorithms are used to adapt the loops. For example, the bandwidth of the CTF may be adjusted via a mean square error (“MSE”) adaptation loop while the equalization of the DFE is adjusted via a least mean square (“LMS”) adaptation loop.

In addition, these loops may be operated at different bandwidths. For example, a DFE loop adaptation process may be allowed to converge with each incremental change in the coefficients that control the CTF loop. Consequently, the bandwidth of the DFE loop may be configured to be higher than the bandwidth of the CTF loop.

A threshold adjust circuit adjusts the DC threshold of the signal provided to the DFE. The threshold is adjustable by means of a tail distribution optimization loop. Hence, this loop uses a different error criteria and a different error algorithm as compared to the other loops.

A clock and data recovery (“CDR”) circuit extracts a clock from the equalized signal. This clock is used to retime the equalized signal to provide output data. The PLL of the CDR circuit is substantially independent of the other loops. The phase of the clock output by the CDR circuit may be adjusted via a mean square error adaptation loop. This phase adjust loop may be operated at a different bandwidth than the CDR loop. For example, the CDR loop may converge 10-20 times faster than the phase adjust loop.

A delay lock loop (“DLL”) circuit generates a low speed clock that drives an analog to digital converter (“ADC”) circuit. The ADC is used to digitize a soft decision signal to provide data for several of the adaptation loops. The DLL runs substantially independent of the other loops. A relative error mechanism is provided for adjusting the phase of the clock that is generated by the DLL and provided to the ADC. Hence, this ADC clock loop uses a different error criteria and a different error algorithm as compared to the other loops.

Exemplary Receiver Components

The operation of the receiver 100 will now be described in an example where data is recovered from a 10 Gbits per second (“Gbps”) serial data signal received from, for example, an optical channel. It should be appreciated, however, that the techniques described herein may be applicable to other applications including other receiver types, architectures, data rates and control loops.

The receiver includes an input stage for amplifying and filtering a received signal 103. The input stage includes a variable gain amplifier (“VGA”) 105, a continuous time filter (“CTF”) 107 and an automatic gain control (“AGC”) circuit 109. This input stage provides a conditioned and relatively constant amplitude signal to the DFE.

The variable gain amplifier 105 amplifies the input data signal 103 in accordance with a control signal received from the AGC circuit 109. The amplified output of the VGA is provided to the continuous time filter 107.

The continuous time filter 107 filters the data signal using, for example, a low pass filter that has an adjustable bandwidth. In general, the CTF reshapes received input pulses to improve the performance of the DFE.

In the embodiment of FIG. 1, a dithering algorithm circuit 173 generates a bandwidth adjust signal (“C_CTF”) 175 to control the bandwidth of the continuous time filter 107. Here, the dithering algorithm circuit 173 may adjust the signal 175 such that a measured mean square error associated with the received signal is minimized.

A filtered data signal 111 from the continuous time filter 107 is fed back to the automatic gain control circuit 109. Under the control of the automatic gain control circuit 109 the variable gain amplifier 105 may appropriately amplify or attenuate small or large amplitude input signals, respectively, to generate an output signal having relatively constant amplitude. In some embodiments the AGC 109 filters a peak detect output through a digital accumulator to generate the control signal provided to the VGA 105. In general, the AGC loop runs continuously and independently of the other loops in the receiver 100.

A threshold adjust loop optimizes the DC level of the data signal 111 from the continuous time filter 107. This DC level optimization is equivalent to optimizing the decision threshold of the DFE slicer. Here, a threshold adjust circuit 117 combines (e.g., adds) a control signal (“C_TA”) 113 from a tail distribution optimizer 189 to the data signal 111. A resultant signal 123 is then provided to a decision feedback equalizer (“DFE”) 115 and a clock and data recovery circuit (“CDR”) 127.

The DFE equalizes the signal 123 by combining the signal 123 with equalized feedback signals (not shown) that may be scaled by one or more equalizer coefficient signals 161. The decision feedback equalizer 115 has an internal feedback loop (not shown in FIG. 1) whereby internal feedback signals are multiplied by (in a two-tap equalizer example) equalization coefficients G1 and G2 (typically negative numbers) provided by signals 161. The resulting scaled equalized feedback signals are added by an internal summer (not shown in FIG. 1) to the data signal 123. Thus, the decision feedback equalizer 115 may subtract a scaled version of one or more previous symbols from the current (that is, current in time) symbol to reduce or eliminate channel induced distortion such as inter-symbol interference.

In general, the values of the equalization coefficients G1 and G2 depend on the level of inter-symbol interference that is present in the incoming signal. Typically the absolute value of an equalization coefficient increases with increasing inter-symbol interference.

The coefficient signals 161 are generated by a LMS algorithm-based adaptation loop. This iterative algorithm updates each coefficient based on its estimate of error obtained from processing an equalized soft decision (“SD”) signal 119 generated by the decision feedback equalizer 115.

The decision feedback equalizer 115 also generates a hard decision data signal 125 (e.g., a binary data signal). As discussed below, the hard decision signal may be generated by, for example, slicing the soft decision signal.

A clock and data recovery (“CDR”) circuit 127 extracts a 10 GHz clock signal 131 (in this 10 Gbps receiver example) from the binary data signal 125 by, for example, aligning the rising edge of the extracted clock 131 with transitions in the binary signal 125. In this way, the clock and data recovery circuit 127 may maintain a desired timing relationship between the binary data signal 125 and the clock signal 131 that the retimer 121 uses to retime the binary data signal 125.

A clock and data recovery adaptation loop may be used to optimize the phase of the recovered clock signal 131. In one embodiment, a phase adjust circuit 195 is controlled by a control signal (“C_PA”) 177 to, for example, make relatively small adjustments in the phase of the clock signal 131. For example, the control signal 177 may create an offset in the detected phase relationship between the clock signal 131 generated by the CDR 127 and the binary data signal 125. The dithering algorithm circuit 173 may then adjust the control signal 177 (thereby affecting the delay) to reduce the mean square error associated with the received signal. Examples of decision feedback equalizers with adjustable clock recovery delay are disclosed in U.S. patent application Ser. No. 10/774,725, filed Feb. 9, 2004, the disclosure of which is hereby incorporated by reference herein.

The binary signal 125 is retimed by a retimer 121 to generate an output data signal 197. The signal 197 thus constitutes equalized data that has been recovered from the incoming data signal 103.

In some embodiments, a demultiplexer (“DMX”) 151 demultiplexes the recovered data signal 197 to generate parallel data signals that are clocked at a slower rate. For example, in FIG. 1 the demultiplexer 151 generates sixteen parallel data signals 153 at a rate of 622 Mbits per second (“Mbps”).

In FIG. 1, error information for several of the adaptation paths is obtained from a digitized version of the soft decision signal 119. An analog to digital converter 163 samples the soft decision signal 119 to generate digital signals that are normalized by a digital automatic gain control circuit (“DAGC”) 165. The digital output 191 of the digital automatic gain control circuit 165 is then provided to several of the adaptations loops.

In general, adaptation need not be performed at the incoming data rate. That is, the parameters that are being compensated for by the adaptation loops typically change at a rate that is significantly slower than the 10 Gbit data rate. As a result, adaptation may be performed at lower speeds to minimize the amount of power and area required by the receiver.

In some embodiments the analog to digital converter 163 samples the soft decision signal 119 using a 155 MHz clock signal 169 generated by a delay lock loop 167. The relative phase of the clock signal 169 determines the point in time in a given symbol of the signal 119 at which the analog to digital converter 163 samples the symbol.

In some embodiments the delay lock loop 167 works in conjunction with a variable delay circuit 181 that may be used to control, to some degree, the phase of the clock signal 169 in accordance with another adaptation loop. Here, a relative error circuit 193 may adjust a delay control signal (“C_ADC”) 179 to vary the point at which the analog to digital converter 163 samples symbols from the soft decision signal 119. In this way, the analog to digital converter 163 may be controlled to sample at approximately the same point in time as the retimer 121. As shown in FIG. 1, the relative error circuit 193 may adjust the correction signal 179 based on at least a portion of output signal 153 and the DAGC output signal 191.

In some embodiments an initialization phase invoked by search engine 185 may be used to ensure that the coefficients for one or more of the loops are at an acceptable initial value when the receiver is powered on or reset. Once an acceptable state is reached, the receiver enters a tracking phase where all the loops are enabled such that the loops will adapt simultaneously. To insure stability, a different operating speed (e.g., bandwidth) may be defined for various loops.

In some embodiments the components 157, 165, 173, 189 and 193 are implemented in the digital domain. Other components such as the search engine 185 and a channel quality monitor 183 also may be implemented in the digital domain. Accordingly, these components may be implemented, for example, as microcode for microprocessors, programmable logical grid arrays, as a state machine, a processor with associated software or similar structures and devices.

Exemplary Control Loops

As mentioned above, the receiver 100 includes several adaptation loops for optimizing the recovery of data from the received signal. The operation of these loops will now be discussed in more detail.

1) Exemplary LMS-Based DFE Loop

As discussed above, a least mean square (“LMS”) algorithm in the DFE loop generates the G1 and G2 coefficients based on the digitized soft decision signal 191. In general, an LMS algorithm adjusts the coefficients based on current and prior samples of the received data. For example, for a two tap DFE the LMS algorithm may be described by the following equations:
g1(n)=g1(n−1)+μ*e*y1 EQUATION 1
g2(n)=g2(n−1)+μ*e*y2 EQUATION 2
n>=1

where g(n−1) represents the coefficient immediately preceding coefficient g(n), μ is a scalar that relates to, for example, the gain of a feedback loop and the speed with which the loop converges, e is an error signal, and y1 and y2 are prior samples of the received data.

2) Exemplary MSE Dithering Algorithm-Based Control Loops

The dithering algorithm circuit 173 uses the signal 191 to generate signals to control the CTF and CDR circuits. Specifically, the bandwidth adjust signal 175 controls the bandwidth of the continuous time filter 107 and the phase adjust signal 177 controls the phase adjust circuit 195 to adjust the phase of the clock signal 131. The phase adjusted clock signal 131 also affects the timing of the clock 169 generated by the delay lock loop circuit for the analog to digital converter 163. In other embodiments, the dithering algorithm may control any number of coefficients, values, loops or other parameters.

In some embodiments, the dithering algorithm circuit 173 modifies the signals 175 and 177 according to a mean square error associated with a received data signal. In FIG. 1, the mean square error is calculated from the digitized soft decision signal 191.

To calculate the square error, the system processes the digital signals 191 received from the digital automatic gain control circuit 165. In some embodiments a sum square error (“SSE”) is generated rather than an MSE to avoid an extra processing step of scaling the SSE to a mean value.

A SSE calculator (not shown) may generate an initial error signal using an adder that subtracts the expected value of a received signal from the actual value of the received signal. Here, the expected value may be generated, for example, by slicing the received signal. A squaring circuit then squares the initial error signal and a summing circuit sums the squared error signals to generate the SSE signal. If an MSE signal is desired the SSE may be normalized at this point. For convenience, the term MSE may be used in the discussions that follow. It should be appreciated, however, that the techniques described with regard to MSE may be applicable to other square error algorithms or other error algorithms.

The dithering algorithm circuit 173 may reduce MSE by measuring MSE, then adjusting one or more of the signals 175 and 177, then re-measuring the MSE to compare the new MSE with the prior MSE. If the MSE decreased, the circuit 173 continues to adjust the signals in the same direction (e.g., up or down) as before. If the MSE increased, the circuit 173 adjusts the signals in the opposite direction. The following equation describes one example of a dithering algorithm:
c(n)=c(n−1)+u(n)
u(n)=u(n−1) if MSE(n)<MSE(n−1)
u(n)=−1*u(n−1) if MSE(n)>MSE(n−1)
n>=1 EQUATION 3

where c is a coefficient or other parameter to be adjusted and u is a unit of adjustment to the coefficient.

In some embodiments the size of the adjustment of the coefficients is dependent on a state of the dithering device 173. For example, the dithering device 173 may have coarse, fine and freeze states such that a coefficient is modified in large steps, modified in small steps or held steady, respectively.

The different adjustment sizes affect the speed at which an optimum parameter value may be obtained. A large adjustment size allows the process to more quickly approach an optimum value if an initial parameter value is far from an optimum value. However, a large adjustment size may continually overshoot an optimum value. A fine or small adjustment size can more accurately pinpoint an optimum value, but a larger number of iterations may be required to reach the optimal value due to the small step size.

A state machine of the optimization process may be initiated in a coarse state. In an initial coarse state, there may be insufficient feedback data to determine when a transition to a fine state is needed. The feedback data indicates the effect of a current parameter value on an error signal and tracking the feedback over time indicates trends in this process. The error signal, an approximation thereof or resulting parameters or changes in the parameter may be the feedback data. The initial coarse state may thus prevent transitions until a requisite amount of feedback data has been collected.

Transition to a fine state may be permitted when a defined threshold is met or passed. The threshold may be based on the feedback being tracked. Here, data samples of the feedback may be added together or approximations of the values may be added together. The feedback or approximation thereof falling below a threshold may indicate that the parameter value has neared an optimal value and finer tuning is needed to obtain the optimal value or approach it.

The fine state may be correlated with a smaller step size or finer granularity in adjusting the parameter. Transition out of the fine state may be disabled until a requisite amount of feedback (e.g., changes in a coefficient value) has been collected that reflects the change in state.

A transition to a freeze or hold state may be made when a threshold is reached. The freeze state locks the value of the parameter. Locking the parameter may prevent inefficiency and may improve the performance of a function associated with the parameter. Without the freeze state the value of the parameter may continuously shift around an optimal value that on average may result in poorer performance than a locked value close to the optimal value. In one embodiment, the parameter value that is locked in is an average of recent parameter values. In another embodiment, the parameter value locked in is the last value prior to the transition to the freeze state or a similar approximation of the optimal value.

A transition to the freeze state may be predicated on conditions in addition to the threshold value. For example, parameters or functions affected by the parameter to be frozen may be included to prevent a freeze that may be adverse or inefficient for other functions. In one embodiment, multiple instances of the optimization process control parameters of different functions in a device or system. These separate optimization process instances may be interdependent. In one embodiment, the condition of one optimization process may affect the other. For example, an optimization process adjusting the coefficient for a continuous time filter may prevent entry into a freeze state until a separate optimization process for a phase adjust circuit enters a freeze state. The phase adjust circuit may have a slower reaction or convergence time than the continuous time filter. Thus, allowing the continuous time filter to enter a freeze state before a phase adjust circuit reaches convergence may be counter-productive as the changes to the phase adjust may disrupt the continuous time filter settings (e.g., coefficients) thereby leading to further adjustment of these settings.

In one embodiment, in the freeze state, a continuous or periodic monitoring of the error signal may be made. If the change in the error signal from a baseline value exceeds a threshold value or similar criteria are met, then the state machine may transition out of the freeze state to a coarse state or other state. In one embodiment, other conditions may force an exit from the freeze state including other instances of the optimization process exiting the freeze state or similar conditions. For example, an exit of either optimization process for related continuous time filter and phase adjust devices may result in the other optimization process exiting the freeze state.

The instances may have other conditions on transitions between states that are dependent on the state of the other instances. For example, an instance controlling a continuous time filter 107 may enter a freeze state only when an instance for a phase shifter 195 is in a freeze state.

Other Exemplary Control Loops

It should be appreciated that the digitized soft decision signal 191 may be used in other adaptation loops and that the above or other adaptations loops may use one or more other signals as a basis for adjusting control signals (e.g., coefficients) for the loops. Two adaptation processes, a threshold adjustment loop and an ADC clock delay adaptation loop, that use the signal 191 and other criteria will now be discussed in some detail.

Exemplary DFE and CDR

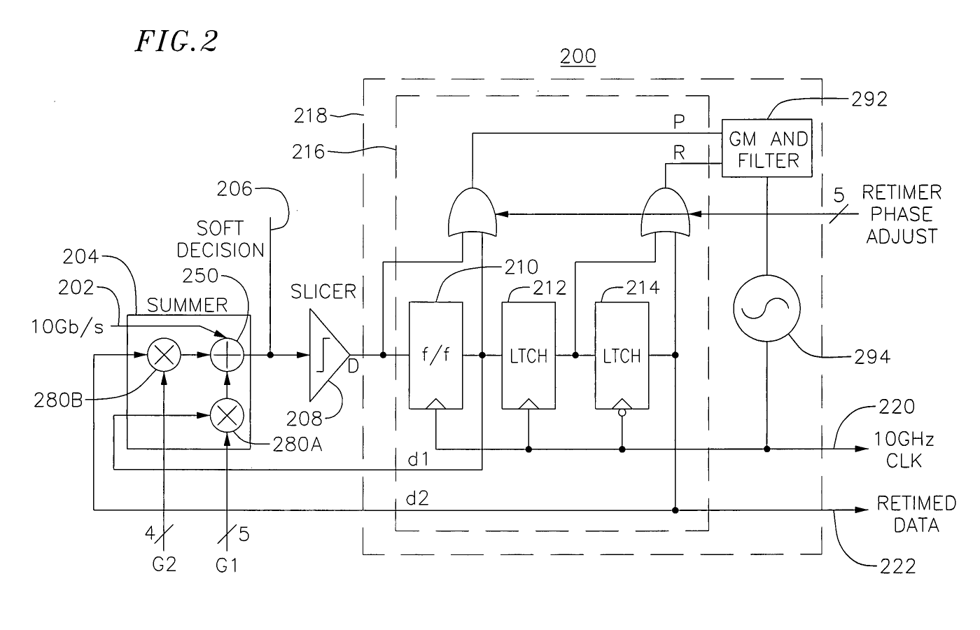

As discussed above, the soft decision signal used by these loops may be generate by a DFE. In addition, the relative error circuit 193 also uses the output data 153 to adjust the phase of the sampling clock for the ADC 163. FIG. 2 illustrates in more detail one embodiment of a two tap decision feedback equalizer and clock and data recovery circuit 200 that may be used to generate the input signals for these loops.

The embodiment of FIG. 2 equalizes received data before it is retimed and incorporates an integrated phase detector and retimer. For example, an input signal 202 (e.g., signal 123 in FIG. 1) is equalized at a summer 204 that adds equalizer feedback signals d1 and d2 (as scaled by coefficients G1 and G2) to the input signal 202. The resultant soft decision signal 206 is provided to a slicer 208 and the output (D) of the slicer 208 is provided to a clock and data recovery circuit (represented by the components within dashed box 218). The clock and data recovery circuit extracts a clock signal 220 (e.g., signal 131 in FIG. 1) and retimes the received data to generate an output signal 222 (e.g., signal 197 in FIG. 1). By equalizing and retiming data in this manner, signal delay problems and clock recovery problems resulting from ISI that exist in conventional devices may be avoided. Accordingly, this architecture may facilitate operation at higher data rates and may operate more effectively in systems with relatively high ISI.

The phase detector comprises the components within dashed box 216. Here, it may be seen that latches in the phase detector are used to generate the retimed data 222. Specifically, the CDR phase detector flip-flops (flip-flop 210 and latch pair 212 and 214) also function as DFE retimers. These flip-flops may be shared because in the architecture of FIG. 2 the flip-flops for the CDR phase detector may operate from the same signals (e.g., binary data signal (D) and the extracted clock signal 220) as would the flip-flops for a DFE retimer. By integrating these phase detector and retimer components this architecture serves to advantageously reduce the number of high-speed components in the receiver.

The data output signals from the two flip-flops also provide the DFE tap signals (d1 and d2) for the DFE feedback loop. The output signals d1 and d2 are multiplied by equalization coefficients G1 and G2 at multipliers 280A and 280B, respectively, and provided to an adder 250. The adder 250 then combines the equalization signals with the input signal 202.

As discussed above, a slicer 208 digitizes the output 206 of the summer 204 to generate the binary data signal (D) that is provided to the first flip-flop 210. In this embodiment, the output of the second flip-flop provides the recovered data signal 222.

Outputs P and R from the phase detector 216 are provided to a charge pump and loop filter 292 which provides a voltage signal to a voltage controlled oscillator (“VCO”) 294. The VCO 294 generates the extracted clock signal 220 that clocks the two flip-flops. Here, the phase of the clock signal 220 may be controlled by a set of retimer phase adjust signals (e.g., signal 177 in FIG. 1).

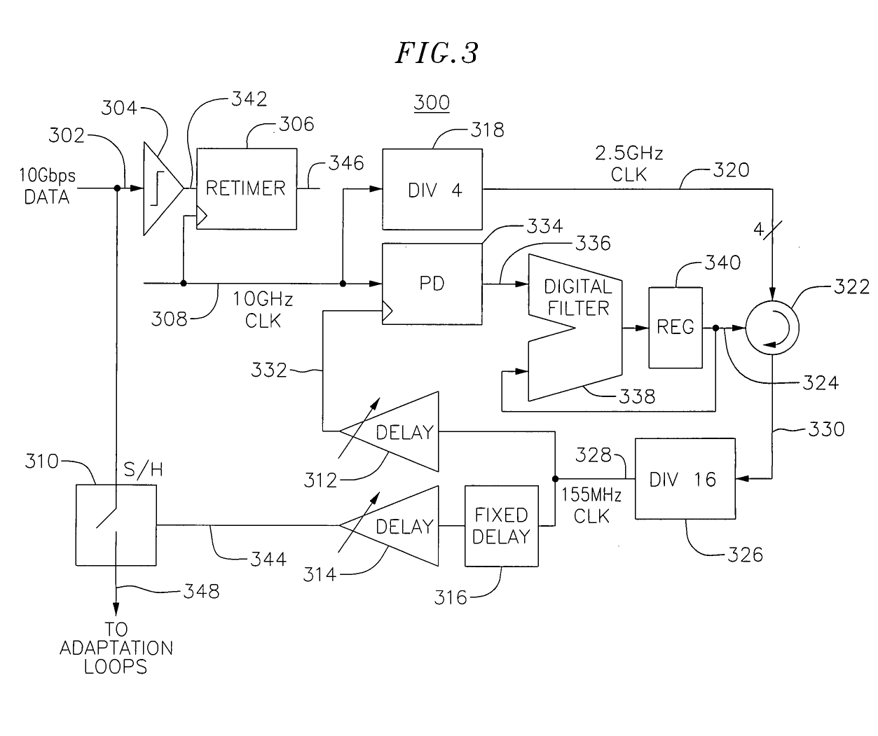

In some embodiments the soft decision signal 206 is used to generate error data for the adaptation loops. For example, the signal 206 may comprise the signal 119 described above in conjunction with FIG. 1. Here, it may be desirable to ensure that the basis for the error data accurately corresponds to the actual data that is generated by the receiver (e.g., the retimed data 222). Accordingly, provisions may be made to ensure that a sampler (e.g., ADC 163 in FIG. 1) samples a symbol in the soft decision signal 206 at a point in time (e.g., a given position in a time representation of the symbol) that corresponds to when the retimer (e.g., flip-flop 210) samples a symbol in the data (D). These timing issues will be discussed in more detail in conjunction with the circuit shown in FIG. 3.

Exemplary DLL and ADC

FIG. 3 illustrates one embodiment of a delay lock loop and analog to digital converter timing circuit 300. An input signal 302, a slicer 304, a retimer 306 and an extracted clock signal 308 may respectively correspond to the signal 206, the slicer 208, the retimer (flip-flop 210 and latches 212 and 214) and the signal 220 in FIG. 2. Similarly, these components may respectively correspond to the signal 119, the slicer (in DFE 115), the retimer 121 and the signal 131 in FIG. 1. A sample and hold (“S/H”) circuit 310 may correspond to the ADC 163 in FIG. 1. Variable delay buffers 312 and 314 and optional fixed delay element 316 may correspond to the variable delay element 181 in FIG. 1. For convenience, a delay adjust input signal (e.g., signal 179 in FIG. 1) is not illustrated in FIG. 3.

The remaining components shown in FIG. 3 may correspond to the delay lock loop 167 of FIG. 1. For example, the delay lock loop may comprise a divide-by-four circuit 318 that generates a 2.5 GHz clock signal 320 from the 10 GHz clock signal 308. The signal 320 comprises an input to a phase interpolator 322 that is controlled by a control signal 324. A divide-by-sixteen circuit 326 generates a 155 MHz clock signal 328 from an output 330 of the phase interpolator 322. The delay buffer 312 delays the signal 328 to provide a 155 MHz clock 332 to a phase detector 334. The phase detector 334 generates an error signal 336 in accordance with a phase difference between the signals 332 and 308. A circuit including a filter 338 and a register 340 filters and accumulates the error signal 336 to generate the control signal 324.

As discussed above, it may be desirable to ensure that the sample-and-hold circuit 310 samples a symbol in the soft decision signal 302 at a point in time (e.g., a position in a time representation of the symbol) that corresponds to when the retimer 306 samples a symbol in its input data 342 (e.g., data (D) in FIG. 2). For example, if one sampler is sampling in the middle of the “eye” of a given symbol, it is desirable to have the other sampler also sample in the middle of the “eye” of its sample.

A conventional phase alignment (e.g., PLL or DLL) scheme may not provide the desired correlation between the sample times of the sample-and-hold circuit 310 and the retimer 306. For example, in a conventional scheme the delay elements 312, 314 and 316 may not be present. Thus, the 155 MHz clock 328 may be used to clock the sample-and-hold circuit 310 and would serve as the lower input signal (instead of signal 332) to the phase detector 334.

Even assuming, however, that the delay lock loop was capable of perfectly aligning the clock signals 308 and 328, the sampling times of the retimer and the sample-and-hold circuit 310 would differ due to the delay imparted by the slicer 304 on the signal 342 sampled by the retimer 306. Moreover, in practice, additional phase inaccuracies may be imparted on the clocks 308 and 328 by other components of the system. For example, the sample and hold times of the samplers 306 and 310 may differ. In addition, the phase detector 334 may not precisely detect phase differences and/or generate absolutely precise error signals to compensate for the phase differences. Also, the delays in the circuit may vary depending on the temperature of the circuit.

To compensate for these delays, the delay elements 312, 314 and 316 may be used to adjust the relative phase of the clock 308 that is used to generate output data 346 and a clock 344 that is used to generate data 348 for the adaptation loops. Here, the fixed delay element 316 may be used to coarsely compensate for the delays in the circuit. For example, the delay of the element 316 may be set to a value that corresponds to typical delays (e.g., the delay through the slicer 304, etc.) in the circuit.

The delay elements 312 and 314 may be used to adjust the relative phases of the clocks 308 and 344. For example, an increase in the delay of the delay element 312 and/or a decrease in the delay of the delay element 314 will cause the phase of the clock 344 to move in a leading direction with respect to the clock 308. Conversely, a decrease in the delay of the delay element 312 and/or an increase in the delay of the delay element 314 will cause the phase of the clock 344 to move in a lagging direction with respect to the clock 308.

Based on the timing of the clock 344, the sampler 310 generates a sampled soft decision signal 348 (e.g., an analog or digital sample) that may be used to generate MSE data as discussed above. In general, this MSE data provides an estimate of the true error in the received signal (e.g., the signal through the path from signal 103 to signal 197). As discussed herein, this MSE data may be used to generate coefficients for adaptation loops and may be used by a search engine to identify an initial combination of coefficients to be programmed into the adaptation loops.

Exemplary Relative Error-Based Control Loop

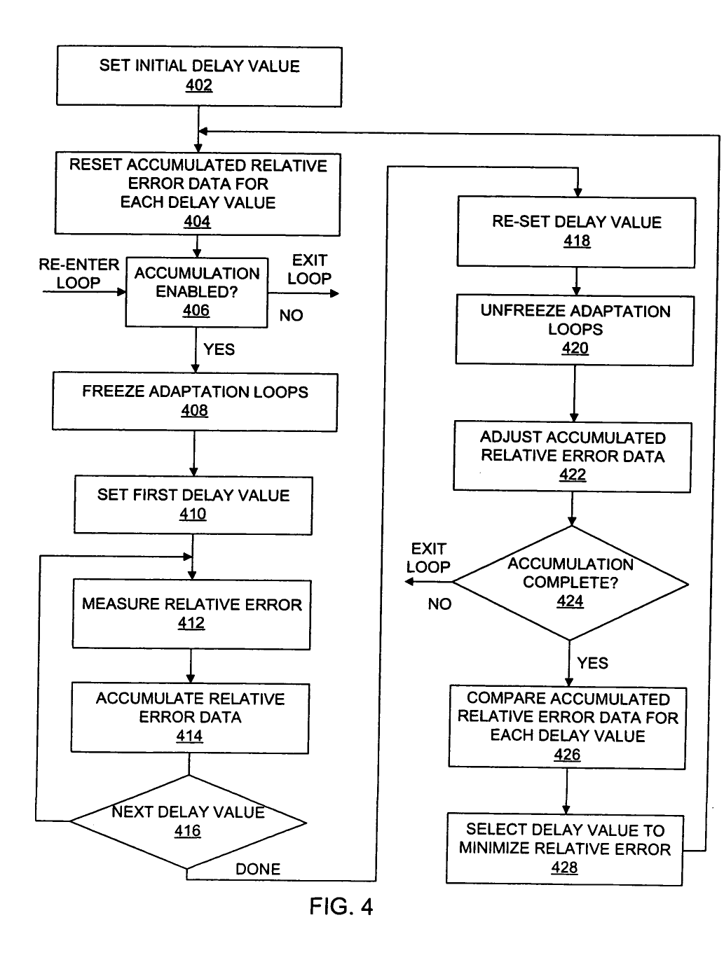

With the above timing issues in mind, one embodiment of a method of controlling the relative phase of sampling clocks (e.g., signals 308 and 344) will be discussed in conjunction with FIG. 4. In particular, the method of FIG. 4 may be used in a communications receiver that incorporates adaptation loops such as the receiver 100 illustrated in FIG. 1.

As represented by block 402, one or more initial delay values are selected for the variable delay element(s). A variety of techniques may be used to select these initial delay values. For example, an initial delay value may be set to a value in the middle of the delay range. This may be achieved, for example by setting the delays of elements 312 and 314 to their minimum values. Alternatively, the delay may be set to a last known value or an algorithm (e.g., executed by a search engine) may be used to relatively quickly get an estimate of the optimum value.

In some embodiments the method involves accumulating relative error data for each possible delay value. Thus, accumulators such as registers, data memory locations, etc., may be provided to store relative error information associated with each delay value. As represented by block 404, as each new accumulation process commences, any prior accumulated relative error information may be cleared from the accumulators.

In some embodiments the procedure may be invoked intermittently (or periodically, etc.) over a period of time. This may be done because it may be desirable to make a relative large number of relative error measurements. For example, taking a large number of measurements may reduce any adverse effects noise, transient conditions, etc., in the system may have on a given relative error measurement (e.g., a comparison of the sampled data symbols from signals 191 and 153 in FIG. 1).

Varying the delay values over a relatively long period of time may, however, adversely affect the operation of the system. For example, as shown in FIG. 1 other adaptation loops may use the data generated by the ADC 163. Since these loops also may be trying to converge to a different desired coefficient value for each different position of the clock, continually modifying the clock that generates this data may cause instability in the system.

The above problem may be avoided by only occasionally performing the relative error procedure. For example, other, more important adaptation loops in the system such as those that generate the DFE and CTF coefficients are allowed to operate at their normal intervals and without modification of the ADC timing. The ADC timing may then be adjusted by enabling the relative error procedure at times when the other loops are not operating (e.g., between the operating intervals of these loops). This does not mean, however, that the ADC timing loop cannot be performed when the receiver is operating. Rather, in general, the ADC clock phase does not impact the main operation of the receiver. That is, changes in the ADC delay values may not corrupt the output data of the receiver.

It should be appreciated that as a result of this intermittent technique a longer time may be needed for the ADC timing adaptation loop to converge (e.g., find the optimum delay value). However, the factors that affect the ADC timing may not change as quickly as the factors (e.g., channel dispersion) that affect other adaptation loops (e.g., generation of the DFE coefficients). For example, typical factors that may affect the ADC timing loop include temperature variations (relatively slow) and process variations (constant once the integrated circuit is manufactured). Moreover, these factors may not involve channel variations. Accordingly, the ADC timing loop may be operated at a slower rate than adaptation loops that are channel dependent.

As represented by block 406, the method thus involves determining whether the accumulation procedure for the ADC timing loop is enabled. If it is not, the accumulation process is not performed. If the procedure is enabled, the operations following block 406 are performed.

As discussed above, several iterations of the accumulation procedure may be invoked before sufficient relative error data has been accumulated. Accordingly, the loop may be re-entered such that the accumulators may already contain relative error data from prior iterations of the loop.

As represented by block 408, to prevent the changes to the delay values from adversely affecting the operation of other adaptation loops in the system and vice versa, the other adaptation loops may be temporarily disabled. It should be understood, however, that provisions may be made to ensure that other more critical adaptation loops are not disabled for too long of a period of time so that, for example, the system will adequately compensate for changes in the system. In the embodiment of FIG. 1, the loops that calculate coefficients for one or more of the signals 175, 177, 113 and 161 may, for example, be disabled. In addition, the adaptation of the delay lock loop may be disabled to, for example, prevent the delay lock loop from interfering with the modification of the delay values.

Blocks 410 through 416 comprise an inner loop that collects relative error for each delay value. Initially, at block 410, the delay (e.g., signal 179 in FIG. 1) is set to one of the values (e.g., −7 in a system where the values may range from −7 to +7).

As represented by block 412, relative error between the input data is collected for one or more symbols (e.g., data bits). In some embodiments the relative error operation consists of an XOR of the two inputs. Thus, if the data bits are the same value the relative error measurement is a “0.” If the data bits are the not same value the relative error measurement is a “1.” In embodiments where several measurements (e.g., collecting data for 128 155 MHz clock cycles at block 412) are made, each relative error measurement may be added to the accumulator that corresponds to the current delay value (block 414). This may be accomplished, for example, by incrementing a counter (e.g., a register) every time the XOR operation results in a “1.”

As represented by block 416, the relative error data is measured and accumulated for the other delay values. In the example above, this may involve setting the delay value to each of the values −7, −6, −5, . . . , 0, . . . +6, +7, and performing the operations of blocks 412 and 414 for each of these values.

Once the entire inner loop has been performed, the system sets the delay value back to the value that was used before block 410 and the adaptation loops are unfrozen (blocks 418 and 420). This enables the system to resume normal operations.

As represented by block 422, the accumulated relative error data in all of the accumulators may occasionally be reduced. This operation may be performed to eliminate the need for very large accumulators. In some embodiments the value in each accumulator is reduced, for example, by the amount in the accumulator with the smallest current accumulated value. Alternatively, reducing the accumulated values may be accomplished by right shifting the data in each accumulator by a predefined or selected number of bits. This operation may be performed at various times such as, for example, randomly, periodically, in response to stimuli such as a minimum or maximum current value in one or more of the accumulators, etc.

The loop represented by blocks 408-422 may be performed several times to accumulate a desired amount of relative error data. For example, in some embodiments approximately one million relative error measurements may be accumulated. If the desired amount of data has not been accumulated at block 424, the procedure may exit the loop until the next ADC clock adaptation loop is enabled. As discussed above in conjunction with block 406, when the loop is re-enabled operations may commence at block 408.

If the desired amount of data had been accumulated at block 424, the process compares the contents of all of the accumulators (block 426). In this way, the process may identify which delay value resulted in the lowest accumulated error (block 428). In some embodiments when more than one accumulator contains the lowest accumulated value, the process may select the desired delay value by averaging the delay values associated with those accumulators. After the system sets the delay value to the selected delay value, the process returns to the beginning of the process to continue to adapt the delay value in accordance with current operating conditions.

In some embodiments, the operating parameters referred to above may be selected based on empirical measurements of the system, simulations or other criteria. These operating parameters may include, for example, the number of samples accumulated, the number of measurements made during each pass through the loop and other factors such as the period of time the algorithm is disabled or the time within which the algorithm is allowed to complete. As discussed herein, factors to be considered in selecting these operating parameters may include, for example, ensuring that the system remains stable and ensuring that the adaptation loops are fully executed frequently enough to adequately adapt to changing conditions in the system.

One example of operating parameters follows. In some embodiments the frequency at which the ADC adaptation loop is performed is the same as the frequency at which the CDR phase adjust signal adaptation loop is performed. In addition, the amount of time each iteration of the ADC loop is enabled is equal to two segments where each segment consists of 1024 ADC clock cycles (e.g., at 155 MHz). The number of measurements taken at block 412 is based on the enable time divided by the number of delay values: floor (2048/15). The number of times through the loop 408-422 is 2ˆ15. Thus, the relative error comparisons at block 426 are performed over 2ˆ23 which is approximately 10ˆ7 bits.

Exemplary Threshold Adjust Loop

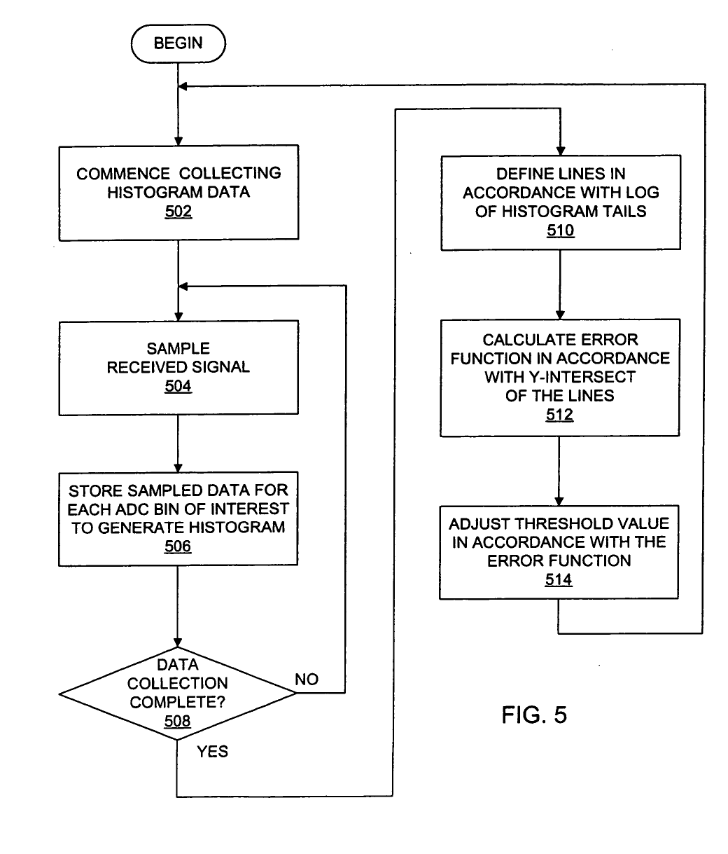

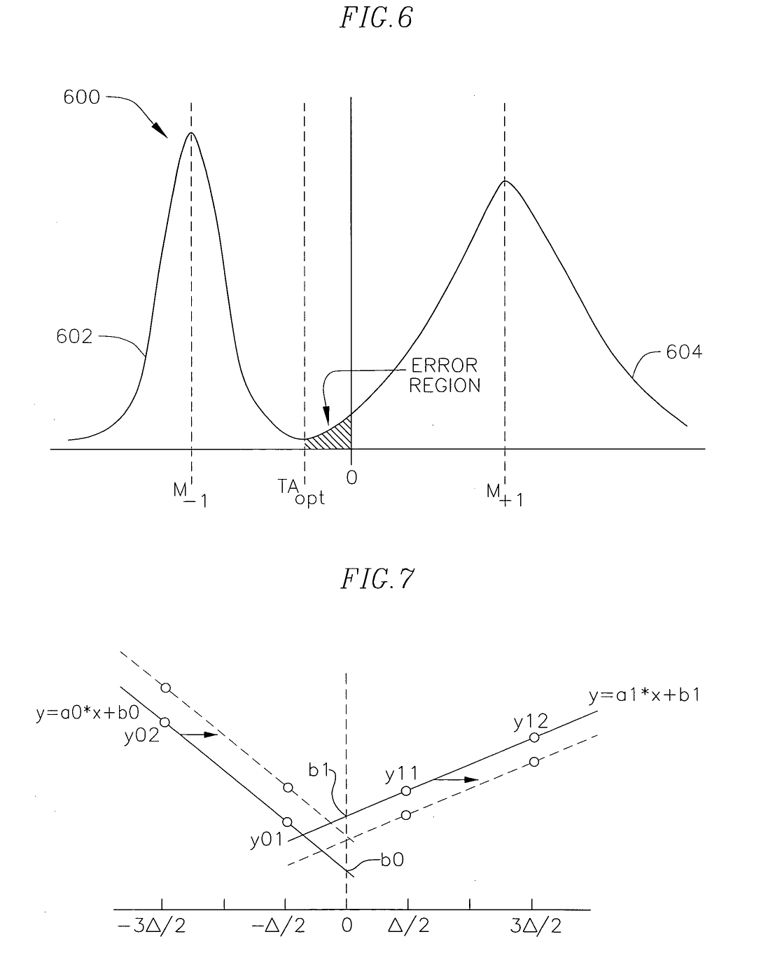

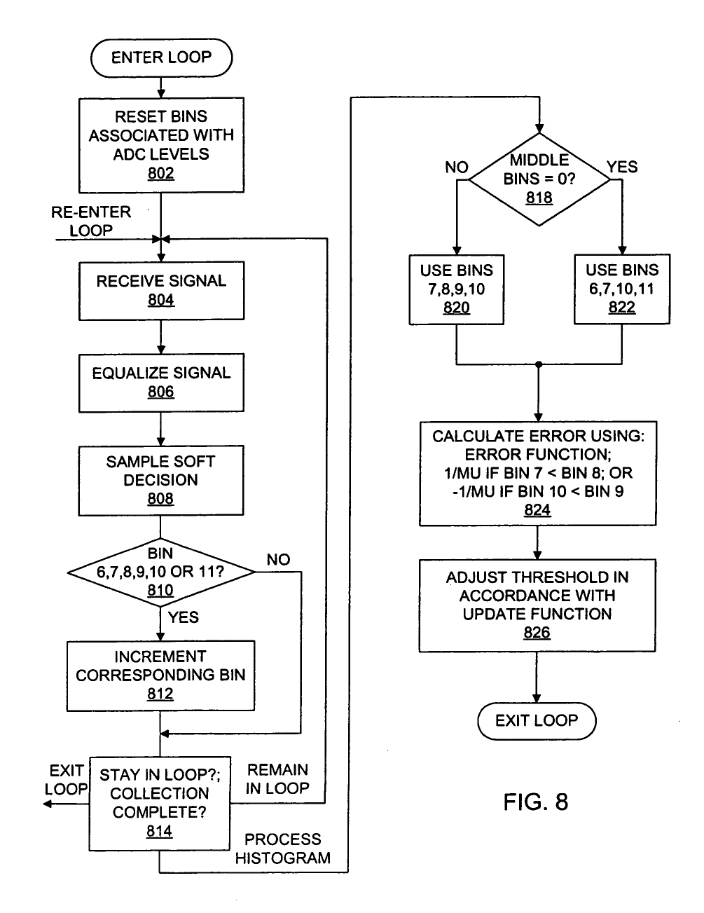

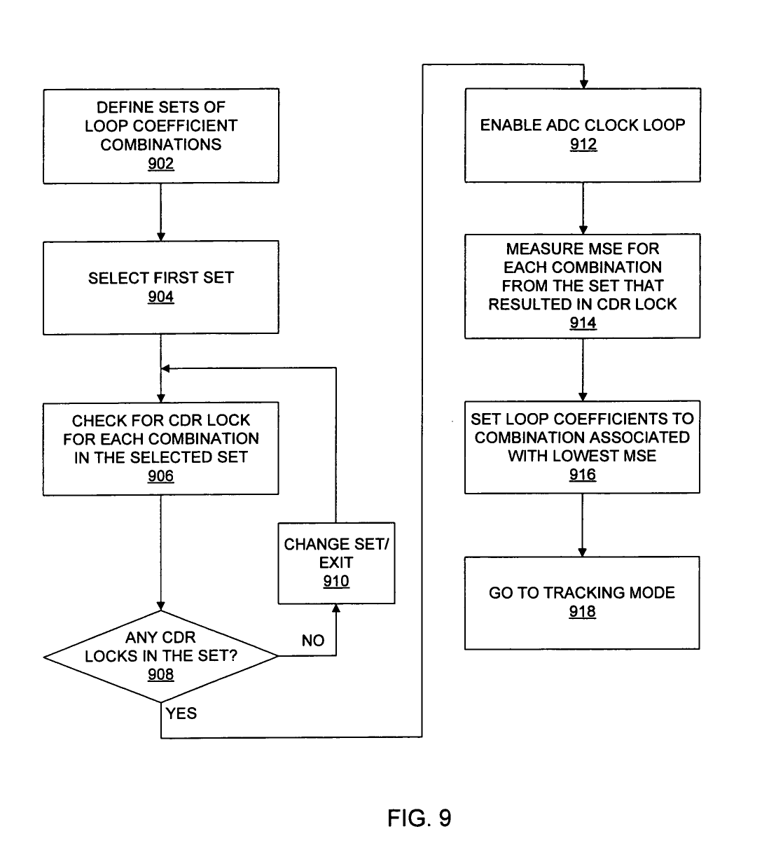

Referring now to FIGS. 5-8, additional details of one embodiment of a threshold adjust loop will be discussed. FIGS. 5 and 8 illustrate embodiments of loop operations. FIG. 6 illustrates one embodiment of a histogram that may be used by the threshold adjust loop. FIG. 7 illustrates graphically one embodiment of a technique for determining how the threshold should be adjusted.

As represented by blocks 502-508 in FIG. 5, the system processes a received signal to generate a histogram associated with the signal. For example, the system may continually sample the received data (block 504) and store the sampled data in a data memory (block 506).

The data collection processes may be commenced at block 502 in a variety of ways. For example, a system may be configured to continually collect data or to collect data on a non-continuous basis. Examples of the latter may include invoking a data collection process periodically or randomly or based on a stimulus or other condition. Similarly, the processes of sampling the data (block 504) and/or storing the data (block 506) may be invoked on a continuous or non-continuous basis.

As shown in FIG. 1, the sampler (e.g., ADC 163) may under-sample the received signal. In this case, the DLL 167 ensures that the sampler samples the signal at appropriate points in time, for example, time-aligned with the clock signal 131.

In some embodiments the sampled data is stored as a histogram. For example, a bin may be associated with each value (e.g., 0-15) that the sampler may generate. A count in a bin is then incremented whenever the sampler generates a value that corresponds to that bin. As discussed in more detail below, the histogram information may be processed to, in effect, determine the characteristics of the eye of the signal. These characteristics, in turn, may be used to define an optimum threshold for slicing the signal.

In some embodiments only a subset of the bins may be of interest. For example, information relating to the eye of a signal may be obtained by processing only those bins at or near the middle of the histogram. In this case, only the information relating to the bins of interest may be stored and/or processed.

As represented by block 508, the data sampling and collection process continues until a sufficient amount of histogram data has been collected. Once the data collection process is complete, the histogram data is processed to determine a magnitude and a direction of any required threshold adjustment.

As discussed in more detail below, the histogram data is processed to extract information that may be used to generate an error function. For example, an optimum threshold level may be derived from an intersection of two lines that may be derived from the histogram data (block 510). Accordingly, identifying a current threshold error may, in some embodiments, involve extracting linear equation information from the tail distribution of the histogram “+1” and “−1” data.

As represented by block 512, the system may calculate the current threshold error (e.g., error function) based on the y-intersect of these lines. Here, the difference between the y-intersect of the lines may relate to the magnitude of a desired threshold adjustment.

As represented by block 514, the system may determine the optimum value for the threshold adjust signal based on the error function. Accordingly, the system may then adjust the threshold adjust signal to cause the threshold to incrementally converge to this optimum value.

Referring now to FIGS. 6 and 7, the histogram data and the error function will be treated in more detail. The histogram 600 represents the signal distribution (y axis) as a function of the intensity of the signal (x axis) over a given period of time. In other words the histogram 600 depicts, for a given intensity value, the relative number of received signals that had that intensity value.

The signal swing from “−1” to “+1” in FIG. 6 represents, for example, a differential electrical signal. Thus, the representation of a “0” in the optical domain is represented as a “−1” in the differential electrical domain of FIG. 6. The received signals corresponding to a “−1” form a bell-shaped curve 602 around a mean M₋₁ while the received signals corresponding to a “+1” form a bell-shaped curve 604 around a mean M₊₁.

This represents that the distribution is relatively high at area M₋₁ and area M₊₁ that respectively correspond to the “1” area and the “0” area of an eye pattern (not shown) of an optical input signal. Conversely, the distribution is lower at the portions of the signal that correspond to an absence or low level of received signal intensity values. For example, the distribution is at or near zero to the right of the upper limit of a “+1” and to the left of the lower limit of a “−1.” The distribution also is relatively low in the center of the histogram that corresponds to the opening of the eye.

In FIG. 6, a default slicer threshold is shown at a halfway point between M₋₁ (the mean of the “−1”s) and M₊₁ (the mean of the “+1”s) which corresponds to “0” value. However, the optimum threshold value is typically not at “0” but may instead be at the point TAₒₚₜ. Hence an error region may exist between the default slicer threshold and the optimum threshold value.

One embodiment of a method of moving a slicer threshold or adjusting the DC level of the received signal to an optimum point (e.g., TAₒₚₜ) will be discussed in more detail in conjunction with FIG. 7. The shape of the histogram close to the TAₒₚₜ point is mainly determined by random noise as opposed to inter symbol interference (“ISI”). As a result, the histogram close to the TAₒₚₜ point may be approximated by a Gaussian distribution. Hence, if the log values of the histogram tails (the regions close to the TAₒₚₜ point) are plotted, two relatively linear lines (corresponding to the “+1” and “−1” tails) may be approximated. The “+1” tails and the “−1” are shown as the left and right solid lines, respectively, in FIG. 7. The intersection of the solid lines further illustrates that the optimum threshold value is not at zero but is instead slightly to the left of zero (e.g., near Δ/2).

Optimum performance may be achieved if the incoming data is, in effect, shifted to the right (as represented by the arrows) to move the tails to the positions represented by the dashed lines in FIG. 7. In contrast with the solid lines, the dashed lines cross each other at “0” (the slicer default threshold). In other words, each of the dashed lines intersects with the y-axis at the same y value. The lines in FIG. 7 may be represented by the line equations shown next to the lines. Thus, the y-intersects of the left lines are defined as b0 and the y-intersects of the right lines are defined as b1. Accordingly, an error function (Err) may be defined as the difference between b1 and b0.

For convenience, the histogram 600 is shown as being defined by relatively smooth lines. In practice, however, the received signal may be digitized using an analog to digital converter. In this case, a histogram of the received data may be created by binning the outputs of the analog to digital converter.

A histogram that results from a digital sampling of the received signal may take the form of a stair-stepped representation that approximates the shape of the bell-shaped curves in FIG. 6. Here, the relative magnitude between successive steps depends, in part, on the number of bits that are used to represent the magnitude of the signal from “−1” to “+1.”

Relative ratios of the log of the digital data from four bins in the histogram are represented in FIG. 7 by the points y02, y01, y11 and y12. For example, the heights of these points may represent the respective ratios of the log of the number of hits stored in each of the four bins. Using two data points per line, b1 and b0 may be calculated as follows:
b0=(3*y01−y02)/2 EQUATION 4
b1=(3*y11−y12)/2 EQUATION 5

where yij=log of the histogram at different ADC codes.

The error function Err may thus be calculated as follows (multiplying by two to simplify the equation):
Err=2*(b1−b0)=(3*y11−y12)−(3*y01−y02) EQUATION 6

Equation 6 may alternatively be written as:
Err=Log [(h11/h01)³*(h02/h12)] EQUATION 7

where hij=the histogram at different ADC codes.

Once Err is zero, the threshold is at the optimum point. Accordingly, Err may be used in an update function to iteratively update the threshold value to move it toward zero or near zero:
TA(n)=TA(n−1)+mu*Err EQUATION 8

In Equation 8 mu is a weighting factor that may be set to provide an appropriate response time for the error function. For example, mu should not be set too low otherwise the update function may take a relatively long time to adjust the threshold. Conversely, if mu is set too high the value of the threshold may oscillate. In some application the value for mu may be selected based on simulations of the system operating parameters or based on other criteria.

From the above, it should be appreciated that only four of the ADC bins (levels) may be required to calculate b1 and b0 and hence Err. In some embodiments these four levels correspond to the four middle levels of the ADC. FIG. 7 depicts four middle levels spaced at Δ intervals that correspond to the least significant bit (“LSB”) value of the ADC.

In some embodiments where a four bit ADC is used to sample the received data, the four bins represented in FIG. 7 may comprise bins 7, 8, 9 and 10. This selection of bins may be better understood with reference to FIG. 6. With a four bit ADC, sixteen different sample values (bins) are defined along the x axis. In addition, in a typical system TAₒₚₜ will always be located between approximately the “0” point and a point that lies to the left of “0” but not significantly to the left of “0.” Accordingly, in this example TAₒₚₜ may only occur near bins 7, 8, 9 and 10 (counting from 0 to 15 from right to left).

Since this algorithm may only use the middle four levels of the ADC, in embodiments where a four bit ADC is not needed for other purposes in the system, the algorithm may be implemented using 4 comparators (2-bit ADC). Furthermore, in some embodiments the ADC may only be used for adaptation of the threshold value and it is not in the data path. As a result, the ADC may be operated at a relatively low speed compared to the received data rate. This, is turn, may advantageously reduce the power requirements for the ADC.

The error function Err may not be valid for all possible combinations of the bins values. Thus, in some cases Err may be set to, for example, 1/mu or −1/mu. In the description that follows the points defining the lines are referenced to their respective bin numbers. Hence, for convenience, the points y02, y01, y11 and y12 may be referred to as bins 7, 8, 9 and 10, respectively, in the discussion that follows.

In one case (case 1), bin 7>bin 8 and bin 10>bin 9. In addition, bins 7 and 8 are associated with the histogram of “−1” and bins 9 and 10 are associated with the histogram of “+1.” In this case, the error function is defined as in Equation 6.

In another case (case 2), bin 7>bin 8 and bin 10>bin 9. However, only bin 7 is associated with the histogram of “−1.” Thus, bins 8, 9 and 10 are associated with the histogram of “+1.” In this case the true slope of the line passing through bin 7 will be steeper than the assumed line through bins 7 and 8. Accordingly, Equation 6 will calculate the wrong value for the slope of the line through bin 7 and for b0 (the true value of b0 will be lower). Nevertheless, the Err calculated by Equation 6 will have the correct sign since it will calculate that b0 is below b1. As a result, the update algorithm may still move the threshold in the correct direction. Moreover, as the threshold is moved, bin 8 will eventually comprise a portion of the histogram for “−1.” Thus, case 2 will eventually turn into case 1. In view of the above, the error function for case 2 may be defined as in Equation 6.

In another case (case 3), bin 7<bin 8 and bin 10>bin 9. Here, only bin 7 is associated with the histogram of “−1.” Thus, bins 8, 9 and 10 are associated with the histogram of “+1.” In this case the true slope of the line passing through bin 7 will be negative while the equation will calculate that the slope is positive (since the equation is based on the assumption that the line passes through bins 7 and 8). Accordingly, Equation 6 will calculate the wrong value for the slope of the line through bin 7 and for b0 (the true value of b0 will be below b1). Moreover, the Err calculated by Equation 6 will not have the correct sign since it will calculate that b1 is below b0. As a result, the update algorithm may move the threshold in the wrong direction.

The algorithm for calculating Err is therefore modified to set Err to 1/mu when bin 7<bin 8 and bin 10>bin 9. By setting Err to 1/mu the update function in Equation 8 will shift the new threshold TA(n) by 1 in the correct direction. As the threshold is moved, bin 7 will eventually become greater than bin 8. Thus, case 3 will eventually turn into case 2.

In another case (case 4), bin 7<bin 8 and bin 10>bin 9. However, bins 7, 8, 9 and 10 are all associated with the histogram of “+1.” Accordingly, the algorithm for calculating Err also is modified to set Err to 1/mu when bin 7<bin 8 and bin 10>bin 9. This is similar to case 3. The update function in Equation 8 will therefore shift the new threshold TA(n) by 1 in the correct direction and bin 7 will eventually become associated with the histogram of “−1.” Thus, case 4 will eventually turn into case 3.

A similar modification of the error function may be made to account for the cases where bin 10<bin 9. In these cases Err may be set to −1/mu.

Provisions also may be made to account for a case where the two middle bins are zero (no hits). This case may occur, for example, when the eye opening of the signal is relatively tall. In this case, the error function may use the next two outer bins for the linear equations. For example, instead of using bins 7, 8, 9 and 10 the error function may use bins 6, 7, 10 and 11.

Referring now to FIG. 8 one embodiment of operations that may be performed by a threshold adjust optimizer in a receiver will be described in more detail. Initially, the threshold optimization loop is entered. As discussed above, the loop may be entered on a periodic or other basis. For example, the loop may be invoked with sufficient frequency such that the loop may efficiently adapt to any changes in the threshold associated with the data. Provisions may be made, however, to ensure that priority is given to other adaptation loops that may be running in the system such as a DFE adaptation loop or a CTF adaptation loop.

As represented by block 802, when the threshold adaptation loop is first invoked the histogram data may be cleared. Here, data memory bins such as registers, accumulators, etc., may be provided to store a hit count associated with each ADC level. Thus, at block 802 each of the bins that hold data associated with a given ADC level may be cleared.

In some embodiments, a single histogram collection process may be invoked intermittently (or periodically, etc.) over a period of time. This may be done because it may be desirable to collect a relative large amount of data. By breaking the process up in this manner, any adverse impact on the performance of other components in the system may be avoided.

Accordingly, as represented by the re-enter loop line, the process may re-enter the loop at this point to continue collecting histogram data. In this case, the bins may already contain data.

As represented by blocks 804-808 the receiver receives an input signal and, in some embodiments, equalizes the received data to provide a soft decision signal for sampling. It should be appreciated, however, that the teachings of the invention are not limited to systems that provide a soft decision signal. For example, a signal that has not been equalized may serve as the basis for making a threshold adjustment. As noted above, the ADC may advantageously sample at a rate that is slower than the data rate of the incoming data. This may be the case, for example, where the threshold adaptation loop does not need to be updated at a relatively fast rate.

As represented by blocks 810-812, the process may only store data associated with a portion of the ADC levels. In the event the data from the ADC is one of the selected bins (e.g., bins 6-11) the corresponding bin may be incremented. Otherwise the ADC data may be ignored or discarded. It should be appreciated that the teachings of the invention may be incorporated into a system that uses a different number of bins, ADC levels, selected bins, etc., than specifically mentioned herein.

As represented by block 814, the process determines whether to remain in a collection loop, exit the loop or adjust the threshold based on the collected histogram. For example, the process may remain in the histogram collection loop by returning to block 804. Alternatively, the process may exit the loop to return at some later point in time as discussed above. At some point a sufficient amount of histogram data will be acquired such that a new decision may be made as to whether the threshold needs to be adjusted. In this case the process passes to block 818.

At block 818 a determination may be made as to whether the middle bins are zero. If not, the process may use bins 7-10 (or some other combination of bins) for the error function (block 820). Alternatively, when the middle bins are zero, the process may use bins 6, 7, 10 and 11 (or some other combination of bins) for the error function (block 822).

As represented by block 824, the process either calculates the error function Err using the log of the bin counts as discussed above or by setting Err to 1/mu or −1/mu. It should be appreciated, however, that the error function may be calculated using other techniques. For example, different equations may be used to represent the tails. Different values may be used instead of 1/mu or −1/mu. In addition, the error function may be based on other ways of processing the histogram information. In a simplified embodiment the process may make a threshold adjustment based simply on the values in the bins. For example, the process may adjust the threshold to ensure that, for example, two bins (e.g., the two smallest bins) have the same or approximately the same number of hits.

As represented by block 826, the process adjusts the threshold in accordance with an update function. In some embodiments, the amount the threshold may be adjusted may be limited. For example, the total threshold adjustment may be limited to +/−30% of the height of the eye window. Again, it should be appreciated that update functions other than those disclosed may be used in view of the teachings herein.

The process then exits the loop to return at some later point in time as discussed at the beginning of this section. In this way the process may provide adaptive adjustment of the threshold since the next invocation of the process will calculate a new error function based on the new (presumably smaller) threshold error.

Exemplary Search Engine

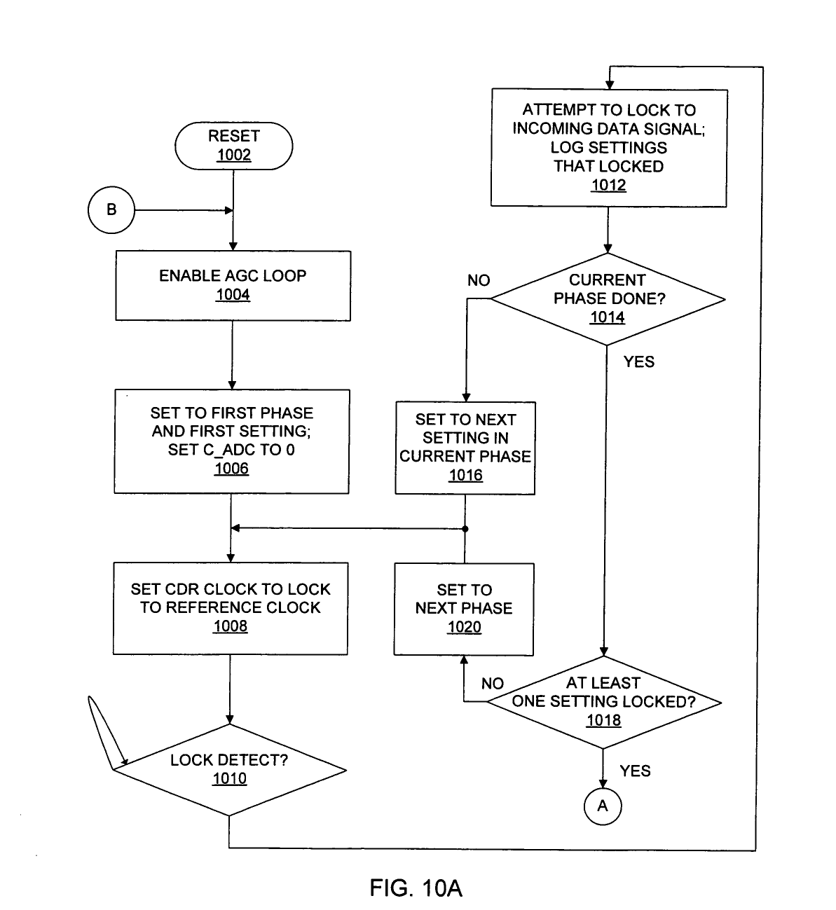

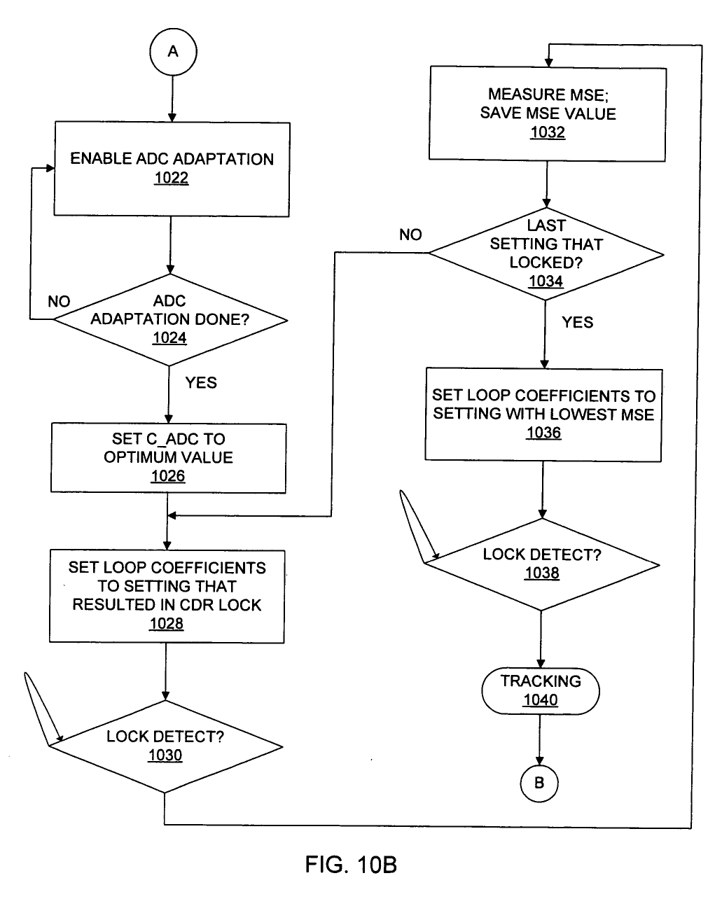

Referring to FIGS. 9 and 10, one embodiment of a search engine for initializing the adaptation loops will be treated. FIG. 9 illustrates high level operations of one embodiment of a search engine. FIG. 10 illustrates one embodiment of operations that may be performed for the loops shown in FIG. 1.

In receiver architectures such as that shown in FIG. 1 where the CDR follows the equalizer, it is possible that some equalizer settings (e.g., coefficient values) may adversely affect the input signal to the CDR to such an extent that CDR lock is lost. Since a locked clock is used to optimize the equalizer coefficients, it is possible that the receiver may become stuck in a mode where lock is never acquired.

In accordance with one embodiment of the invention, a search engine may sequentially program various coefficient combinations into the receiver to determine which combination or combinations of coefficient values result in CDR lock. It may be necessary to try more than one combination because in some applications input signal variation may result in an inability to define a single combination that results in CDR lock for all systems and all conditions.

Provisions also may be made in an attempt to ensure that once tracking is enabled the coefficients do not drift in the wrong direction thereby resulting in a loss of lock. Such a situation could arise, for example, when the initial coefficients that were selected are at or near a “boundary” of a CDR locking region. In this case, an adaptation algorithm may attempt to adjust the coefficients in the wrong direction (e.g., outside the CDR locking region).

Provisions also may be made to improve the time it takes for the search engine to select a preferred set of coefficients. That is, since it may take a relatively long time to acquire lock, it is desirable to reduce the number of combinations.

Referring to FIG. 9, initially several sets of loop coefficient combinations are defined for the search process (block 902). For example, a first relatively small (in number) set of coefficient combinations may be defined that result in lock for the majority of systems and operating conditions. One or more other sets of coefficient combinations may then be defined that result in lock for other systems and operating conditions. For example, in one embodiment, a first small set of (e.g., 6) coefficient combinations may result in lock 95% of the time, while a second larger set of (e.g., 24) coefficient combinations may result in lock for approximately the remaining 5% of the cases. It should be appreciated that other sets of coefficient combinations may be defined to include various types of coefficients, various coefficient values, and various numbers of coefficient value combinations. Moreover, such combinations may result in lock a percentage of time that depends on the system design and operating conditions (e.g., temperature, channel, noise).

A variety of criteria may be utilized for determining which loop coefficients are to be included in a combination and the initial values for those coefficients. For example, simulation or tests may be run to determine which coefficients have the most impact on the CDR not locking. In some applications, the initial values for the selected coefficients may be set to provide several values across the spectrum of possible values for that coefficient. In some applications, it may be possible to find a value for a given coefficient that works well in all or most cases.

The search engine then attempts to determine which of the coefficient combinations in a first smaller set of combinations results in lock. Accordingly, as represented by block 904, the search engine initially selects the first set of combinations to test. As noted above, preferably this set of combinations is defined such that at least one of the combinations in this smaller set of combinations results in a lock condition for a significant percentage of systems and conditions.

As represented by block 906, the search engine determines whether lock may be achieved with any of the combinations in the selected set. In some embodiments the search engine disables the adaptation of the corresponding loops, sets the coefficients to one of the combinations, and determines whether this combination results in lock. The search engine then repeats this process for the other combinations in the selected set.

As represented by block 908, if none of the combinations in the first set result in lock, the search engine may perform the operations of block 906 for each of the combinations defined in one or more other sets of combinations (block 910). In one embodiment a second set includes more combinations than the first set. In this way, although it may take longer to test all of the combinations in the second set, a high probability of achieving lock may be realized at this phase of the process. In the event lock is not achieved for any of the combinations in any of the sets, the search engine may exit the loop to restart from the beginning (e.g., block 902) or it may exit the loop and generate an appropriate error indication (block 910).

When more than one of the combinations results in CDR lock, the search engine selects one of the combinations depending on which combination provides the lowest square error (e.g., MSE, sum square error, etc.). For convenience, the term MSE may be used herein to refer in a general sense to square error. As represented by block 912, in some embodiments the search engine enables the ADC loop and allows that loop to optimize before measuring MSE. Then, as represented by block 914, the search engine changes the coefficients to the values for each combination, lets each system converge, then measures MSE.

As represented by block 916, the search engine sets the initial loop parameters to the set of coefficients that provided the best (e.g., lowest) MSE measurement. As represented by block 918, the search engine then turns the system over to a tracking mode. In tracking mode the adaptation loops are allowed to converge to their optimum values.

Referring to FIG. 10, one embodiment of operations that may be performed in a system such as the one shown in FIG. 1 will be described in more detail. The operations represented by blocks 1006-1020 involve setting the loop coefficients to various combinations to determine which combinations result in CDR lock. In this example, two separate phases are defined, each of which is associated with a different set of coefficient combinations. In this way, a set of combinations that has a high probability of obtaining lock may be tried first. Moreover, the first phase may be relatively fast since it may include a relatively small number of combinations. Then, as a back-up in case the first phase does not result in CDR lock, a second set of combinations may be used in the second phase. This second set of combinations may include a larger number of combinations to increase the likelihood that CDR lock may be achieved during this phase.

The operations represented by blocks 1022-1036 involve identifying the combinations that is associated with the lowest MSE. Prior to measuring MSE, however, the ADC loop is allowed to optimize.

The loop coefficients are then set to the combination that results in CDR lock and has the lowest MSE. At this point the initialization phase terminates and the loops enter a tracking phase.

The initialization phase commences at block 1002 (e.g., after a hard or soft reset). At this point all of the loops are frozen (adaptation disabled) and the coefficients are set to a default value.

As represented by block 1004, the AGC loop is then enabled. Once the AGC loop locks, the output swing of the AGC loop (e.g., signal 111 in FIG. 1) will be set to the desired value.

At block 1006, the search engine commences the first lock detect phase. As discussed above, the type, number and values of the coefficients for a given phase may be defined as a result of empirical testing, simulations, analysis or any other method of selecting the coefficients that indicates that these values are most likely to provide CDR lock. Here, a tradeoff may be made between the number of combinations in the first group versus the percentage of systems or configurations for which at least one combination in the group results in CDR lock.

In one embodiment the first phase includes 6 settings (e.g., 6 different combinations of loop parameters). For example, the first phase may include three possible phase adjust settings of 8, 16 and 24 (out of potential settings of 0 to 31). Hence, the phase adjust settings are essentially spread over the range of the possible 32 settings. The first phase also may include CTF settings of 0 and 16 (out of potential settings of 0 to 30).

The DFE coefficients may be held constant. For example, G2 may be set to 0 and G1 may be set to 16 (out of potential settings of 0 to 31).

In some embodiments the ADC setting may be fixed as well. For example, the ADC settings may be set to the middle of the range (e.g., set C_ADC to 0 for a range of −7 to +7).

At blocks 1008-1012 an attempt is made to acquire lock for the CDR. This process involves a frequency acquisition phase and a phase acquisition phase. The DLL adaptation loop may be enabled during this time to provide a coarse alignment between the ADC clock (e.g., clock signal 169) and the 10 GHz clock (e.g., clock signal 131).

As represented by block 1008, the CDR is initially configured to lock to a reference clock (frequency acquisition phase). In this way, the CDR will be locked to a frequency that is very close to the frequency of the clock that generated the received signal. The search engine then monitors a lock detect signal from the CDR circuit to determine when the CDR has locked (block 1010).

During the phase acquisition phase, represented by block 1012, the CDR is configured to attempt to lock to the incoming signal (e.g., signal 125 in FIG. 1). The length of time that the search engines waits for the lock detect signal may be programmable. In one embodiment, the wait period is on the order of 400 μS. If lock has not been detected by the end of the time period the process proceeds to block 1014.

If the CDR locked to the incoming signal the current set of coefficients is logged. For example, an array (e.g., Lock_Set[i]) indexed by an index value (e.g., “i”) corresponding to the current combination may be set to indicate a lock condition.

At block 1014, the search engine determines whether all of the combinations of the current phase have been checked. If not, at block 1016 the loop settings are set to the next coefficient combination in the current phase (e.g. a next one of the six settings in the first phase). The process then returns to block 1008 to determine whether CDR lock may be obtained with the new combination.

If, at block 1014, CDR lock was attempted with all of the combinations for the first phase the process proceeds to block 1018. If none of the combinations resulted in CDR lock the search engine proceeds to the next phase (block 1020). As discussed above, a second phase may contain a set of combinations that are different than the combinations in the first phase. The combinations in the second phase may be selected so that CDR lock may be achieved in systems and under conditions other than those that typically achieve lock during first phase. In addition, the next phase or phases may include a larger number of combinations to improve the likelihood that CDR lock may be achieved.

In one embodiment the second phase includes 24 settings. For example, the phase may include five possible phase adjust settings of 0, 8, 16, 24 and 31 (out of potential settings of 0 to 31). Again, the phase adjust settings are spread over a range of the possible 32 settings. The second phase also may include CTF settings of 0, 16 and 30 (out of potential settings of 0 to 30). In addition, for the DFE settings, G1 may be set to 16 and 30 (out of potential settings of 0 to 31). Again, G2 may be maintained at 0. In the second phase, however, the combinations from the first phase will not be repeated. Hence, of the 30 possible combinations from the above settings only 24 (30-6) will be used.

The process thus returns to block 1008 and the loop consisting of blocks 1008-1016 is repeated to determine which, if any, of these 24 combinations results in CDR lock. If, at block 1014, CDR lock was attempted with all of the combinations for the second phase the process proceeds to block 1018.

Assuming lock was achieved with at least one combination during the process of blocks 1008-1018, the process proceeds to block 1022. At blocks 1022-1024, the ADC loop adaptation is enabled to allow the ADC loop to optimize. Initially, the DLL loop may be enabled to provide a coarse alignment between the ADC clock and the 10 GHz clock. In addition, the loop settings are set to one of the combinations (e.g., the first combination) that resulted in CDR lock. Of note is that the ADC loop as described herein is based on a relative error measurement. Hence, as discussed above, the ADC loop is essentially independent of the channel. In other words, the ADC loop would typically converge to the same value regardless of which combination of coefficients was selected for the CTF, DFE, phase adjust and threshold adjust loops.

At block 1022 the search engine allows the ADC loop to acquire a sufficient number of samples to obtain a reliable relative error measurement. In one embodiment the number of cycles (of, e.g., the 155 MHz sampling clock 169) for each ADC setting includes 6 cycles for an ADC update and 130 cycles to accumulate relative error for the current ADC setting. With 15 ADC settings the number of clock cycles is thus 2040. In addition, 8 cycles are added to this total for waiting for the next accumulation. Accordingly, the ADC adaptation loop completes in 2048 samples in this example.

As represented by block 1024, the operations of block 1022 are repeated to ensure that the ADC loop has optimized. In one embodiment the process is repeated 1024 times. At block 1026, the search engine sets the ADC coefficient based on the relative error measurements. In one embodiment, the ADC coefficient is set to provide the smallest relative error value.

At blocks 1028-1034 the search engine determines which one of the combinations that resulted in CDR lock provides the lowest MSE. Initially at block 1028, the search engine sets the loop settings to one of the combinations. As represented by block 1030, the search engine waits to determine whether the CDR still locks for that combination. If so, the search engine calculates an MSE for that combination. For example, the system may accumulate and process the digitized soft decision signal 191 to generate an MSE value. Each MSE value may then be stored in a data memory.

At block 1034, the search engine determines whether an MSE calculation has been performed for each of the combinations that resulted in CDR lock. If not the process returns to block 1028 where the loop settings are set to the next combination.

If at block 1034 all of the combinations have been tried, the loop setting are set to the combination that resulted in the lowest MSE (block 1036). At block 1038 the search engine again verifies that the CDR is locking for this combination.

Finally, at block 1040 the initialization phase terminates and the receiver is set to a tracking phase until the system is reset. In the tracking phase, the other loops (threshold adjust, DFE LMS and CDR phase adjust) are enabled and each loop is allowed to adapt to its optimum value.

Exemplary Loop Architecture and Control

Once the receiver is in the tracking phase, the operation of the loops may be controlled to meet design objectives. For example, the loops may be operated at different bandwidths depending on the rate of change of the conditions for which each loop is providing compensation. The loops may be configured to collect data over a time period that is sufficient to compensate for any transient conditions (e.g., noise) in the system. Also, some loops may be operated at different bandwidths to prevent the operation of one loop from interfering in any significant way with the operation of another loop.

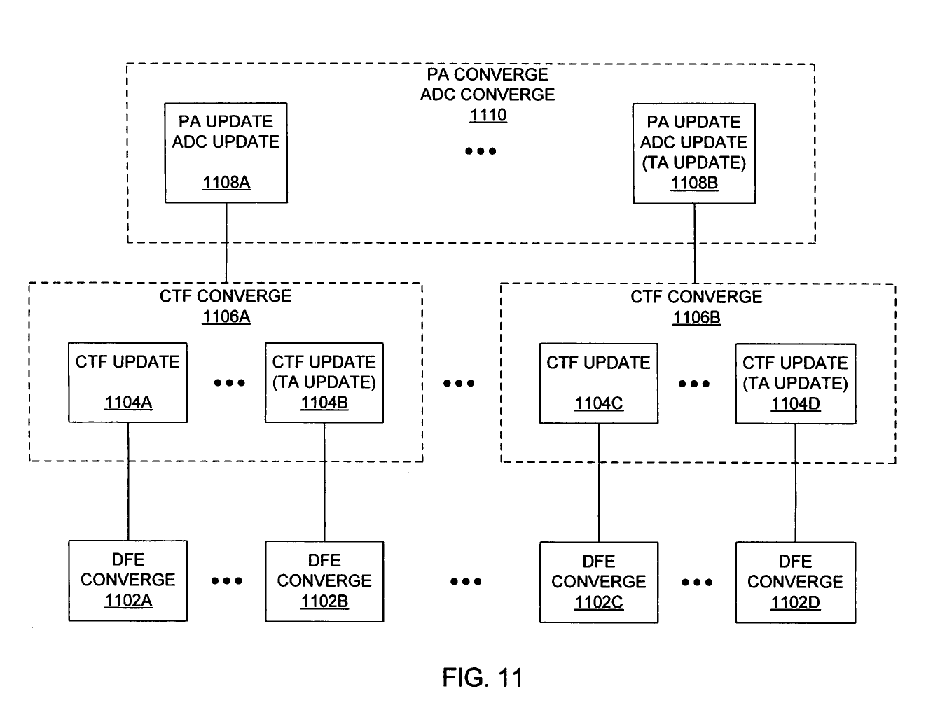

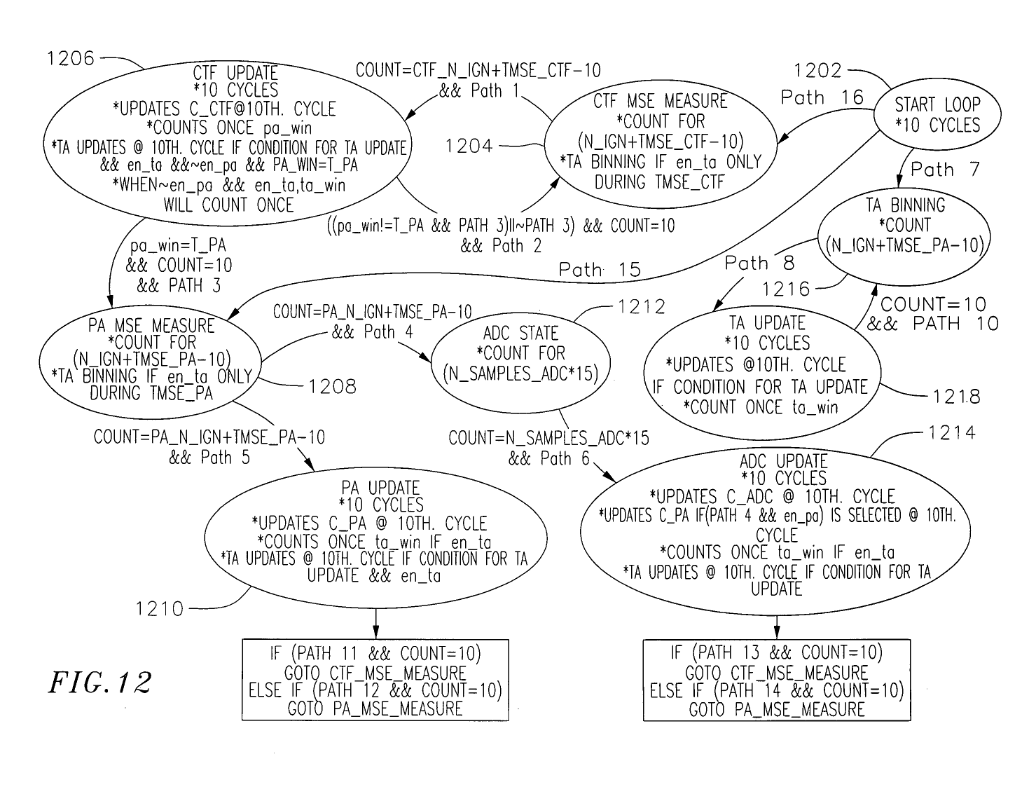

Referring to FIGS. 11 and 12, one embodiment of an adaptation loop control process will be discussed. FIG. 11 describes the loop control process at a relatively high level. FIG. 12 describes in more detail loop operations that may be employed in a receiver such as the one described in FIG. 1.

Briefly, the loop operations involve calculating an error value (e.g., a square error such as sum square error or mean square error, a relative error, a tail distribution, etc.), changing the value of a control coefficient to adjust the characteristics of one of the components in the receiver, re-calculating the error value, comparing the prior error value and the new error value, then re-adjusting the coefficient in a manner that tends to reduce the error value.

In one embodiment the loop control process operates the loops in a nested manner. For example, the process may first enable one loop algorithm to adjust its parameter until the algorithm converges. The process may then enable a second loop algorithm to adjust its parameter by one step, then repeat the loop algorithm for the first loop until the first algorithm again converges. The process may then determine whether the error has been reduced. If so, the process enables the second loop to adjust its parameter in the same direction. If the error has not been reduced, the second loop adjusts its parameter in the opposite direction. This process may be repeated until the second algorithm for the second loop converges.

In the embodiment described below, the DFE loop runs the fastest, the CTF loop runs the next fastest, the PA and ADC loops run the next fastest and the TA loop may run at the speed of the CTF loop or the PA and ADC loops. It should be appreciated, however, that the timing set forth herein is merely one example. A variety of different timing relationships may be used in a system that incorporates the teachings of the invention.

In the examples described herein, some of the loops may not be entirely independent. Accordingly, some of the loops may be defined so that they are invoked at a different rate than the other loops to avoid interference between loops. For example, the relative timing of the loops may be based on the time constant of each loop. Here, the time constant of a loop may be defined as the time in which the coefficient settles to 1/e (where e is the constant e) of its final value. To maintain the stability of the loops it may be desirable to adjust the coefficients for each loop at a rate that ensures that the coefficient for the loop will not be changed for a period of time that is less than the time constant of the next fastest loop. In some embodiments each nested loop may be invoked at a rate that is 10-20 times slower than the next fastest loop.

Typically, the bandwidth of the loops may depend on the rate at which the corresponding errors or other conditions to be corrected occur. In general, the loops that compensate for variations that change at a faster rate will be invoked more frequently.

For example, the LMS algorithm is used to correct errors caused by the characteristics of the channel such as polarization mode dispersion. These characteristics may change relatively frequently due to external conditions. Such changes may be particularly prevalent in relatively long channels.

The continuous time filter also may be used to compensate for changes in the channel such as chromatic dispersion. However, since the decision feedback equalizer typically provides more powerful equalization, the LMS algorithm may be performed more often than the continuous time filter algorithm.

While the PA may provide some compensation for the channel characteristics, the adjustments for the PA primarily correct slowly varying conditions such as temperature and power supply drift or relatively constant conditions such as process variations. Similarly, the adjustments for the analog to digital converter timing primarily correct these types of slowly varying conditions or relatively constant conditions. Accordingly, the algorithms for these components may be performed at a slower rate.

FIG. 11 graphically illustrates an example of nesting of the above loops. Here, the DFE coefficients may be continually updated by the LMS algorithm. Consequently, the DFE loop may be continually converging as represented by the blocks 1102A-1102D. Here, the ellipses represent additional DFE converges that may occur between the DFE converges that are shown.

In this example, CTF coefficients are updated periodically as represented by blocks 1104A-1104D. The ellipses between blocks 1104A and 1104B represent additional CTF updates that may occur between the updates 1104A and 1104B. Typically, a modification of the bandwidth of the CTF that results from the modification of the CTF coefficients will cause the LMS algorithm circuit to adjust the values of the feedback coefficients G1 and G2. This may occur because the prior values of the coefficients G1 and G2 may not provide the optimum scaling of the feedback signals to reduce ISI in input signals that are band-limited by the new bandwidth of the CTF. Accordingly, each time the CTF loop updates the CTF coefficients, the CTF algorithm waits for the LMS algorithm to converge to the new values of G1 and G2 before determining the effect of the new bandwidth coefficient on the MSE.

The algorithm then collects error signals to calculate a new MSE. To provide an accurate (e.g., relatively noise free) measurement of MSE the error signals may need to be sampled over a relatively long period of time. For example, 1000 error samples may be taken to generate an MSE. In this way, variations in the MSE due to, for example, the data pattern or transient noise may be reduced or eliminated.

Next, the algorithm compares the new MSE with the prior MSE. If the new MSE is lower (i.e., smaller) the algorithm adjusts the bandwidth coefficient in the same direction as the previous adjustment, if any. If, on the other hand, the new MSE is higher (i.e., larger) the algorithm adjusts the bandwidth coefficient in the opposite direction.

The algorithm continues to adjust the signal 175 for the CTF until the algorithm converges (represented by the dashed blocks 1106A-1106B). The ellipses between blocks 1106A and 1106B represent that additional CTF converges may occur between the CTF converges 1106A and 1106B. In some embodiments, the algorithm may be deemed to have converged when a value of the CTF coefficient is found that provides the smallest MSE.

In practice, however, it may be more efficient to define the convergence by the selecting a maximum number of adjustments for a given coefficient. For example, based on analysis, tests, estimations, etc., it may be determined that convergence for the CTF occurs in practically all cases within 20 adjustments of the bandwidth. Accordingly, the operation of the algorithm may be simplified by terminating the adjustment of the coefficient after the defined number of adjustments. In other words convergence may be defined as occurring after a given number of iterations through a loop.

After the CTF loop converges (e.g., after a predefined number of CTF updates), the value of the PA coefficient may be adjusted (as represented by blocks 1108A-1108B). The ellipses between blocks 1108A and 1108B represent that additional updates may occur between the updates 1108A and 1108B. Depending on whether the MSE increased or decreased, the PA coefficient is adjusted in an appropriate direction. The above process may be repeated until the PA coefficient converges (as represented by dashed block 1110).

The value of the ADC timing coefficient also may be adjusted at blocks 1108A-1108B. Depending on whether the relative error increased or decreased, the ADC coefficient is adjusted in an appropriate direction. The above process may be repeated until the ADC loop converges (again, as represented by dashed block 1110).

The TA coefficient may be adjusted when either of the CTF, PA or AGC coefficients is adjusted. This is represented in FIG. 11 by the parenthetical “TA UPDATE” in blocks 1104B, 1104D and 1108B. To ensure that a sufficient amount of TA error data (e.g., tail distribution data) is collected and to ensure that the data for the TA adjust algorithm reflects the true conditions of the receiver, the data for the TA adjust algorithm may be collected while some of the other loops are running. In one embodiment, however, the TA data is not collected when the DFE coefficients are converging to prevent the DFE adjustments from adversely affecting the collection of TA error data.

The value of the TA coefficient may thus be adjusted depending on whether the TA error data increased or decreased after the adjustment. This process may be repeated until the TA loop converges.

From the above it should be appreciated how the loops illustrated in FIG. 11 operate at different bandwidths. For example, an update operation in a loop on a higher row in the figure may be performed each time a lower loop converges. As a result, a loop on a lower row in the figure converges more frequently than a loop on a higher row.

With the above overview in mind, additional details of one embodiment of the timing and operation of the adaptable loops of FIG. 1 will be described in conjunction with FIG. 12 and Table 1. Initially, some of the characteristics of the adaptation loops that may be used in the embodiment of FIG. 1 are presented.

The AGC loop is a self contained loop and is substantially if not completely independent of others since it may be based, for example, on the RMS value of the incoming signal. The AGC loop runs constantly and its bandwidth may be adjusted, for example, between 2-200 KHz.

The CDR PLL is also substantially if not completely independent of the other loops. The CDR PLL also may run either constantly or substantially constantly. As discussed herein, the CDR PLL lock process may include frequency acquisition and phase acquisition phases. The bandwidth of the CDR PLL may be much higher than the other loops. For example, the CDR PLL may have a bandwidth on the order of 2 MHz.

The DLL also is substantially if not completely independent of the other loops. The DLL also may run either constantly or substantially constantly. As discussed herein, DLL tracking may be temporarily stopped when other loops are being adjusted. In one embodiment, the DLL may have a bandwidth on the order of 100 KHz.

In one embodiment, the LMS, CTF, PA and TA loops may be configurable depending on system design requirements. For example, the loops may be enabled or disabled. In addition, the timing of each loop may be controlled.

Of these loops, the LMS loop has the highest bandwidth because it typically has the most significant effect on the equalization of the received signal. In one embodiment the LMS may have a bandwidth on the order of 50 KHz and a 155 MHz update rate.

In one embodiment the CTF and PA loops both use a dithering MSE scheme. Here, steps may be taken in order to avoid instability between the two loops. In one embodiment the CTF loop has a bandwidth on the order of 2 KHz and a 70 kHz update rate and the PA bandwidth is at least an order of magnitude lower than the CTF loop bandwidth.

This may be accomplished, for example as follows. First, the CTF loop may be allowed to converge. Once the CTF loop has converged, the PA loop coefficient is changed by one step and CTF is allowed to converge again. In other words, each time the PA loop coefficient is changed, the CTF loop is allowed to optimize its value again. The PA loop is thus comparing the MSE of two different PA values where CTF had converged to its best point.

In the embodiment discussed above, the TA loop is optimized using tail distribution data. As a result, the TA loop is substantially independent of the CTF and PA loops (as well as the other loops). Accordingly, in one embodiment the TA loop may be adapted at the same time as the CTF loop or one of the other loops.

The ADC timing loop compensates for process, voltage and temperature (“PVT”) variations associated with the receiver integrated circuit. Accordingly, the speed of the ADC loop may be relatively slow. In one embodiment the convergence time of the ADC loop is in seconds. In addition, in applications where a relatively large amount of relative error information needs to be collected to obtain reliable data, the ADC may not converge to a specific optimum value. Rather, the adaptation loop may collect relative error data for each phase setting (e.g., C_ADC=−7 to +7) in a manner that provides acceptable ADC operation and a reasonable ADC loop bandwidth.

FIG. 12 illustrates an example of loop operation for four of the adjustable loops discussed above. In particular, FIG. 12 illustrates how an adaptation scheme may invoke one or more of these loops.

As will be discussed in more detail below, Table 1 describes the loops paths and the timing relationships of the loops depending on which loops are enabled. For example, the four columns on the far left side of Table 1 establish the 16 possible configurations of the four loops. An entry of “1” indicates that the loop is enabled while an entry of “0” indicates that the loop is disabled.

The column on the far right of Table 1 lists the paths in the state diagram of FIG. 12 that are enabled for each of the 16 configurations. For example, the first row relates to the system remaining at the Start Loop state. Hence, no paths are selected. Alternatively, when only the TA loop is enabled (the second row in Table 1), paths 7, 8 and 10 are enabled.

TABLE 1

| | | | | | | Inserted |
|---|---|---|---|---|---|---|
| CTF | ADC | PA | TA | PA period | TA period | Paths |
| 0 | 0 | 0 | 0 | — | — | None |
| 0 | 0 | 0 | 1 | — | N_ign + Tmse_PA | 7, 8, 10 |
| | | | | | or T_TA*N* | |
| | | | | | (N_ign + Tmse_PA) | |
| 0 | 0 | 1 | 0 | N_ign + Tmse_PA | — | 5, 12, 15 |
| 0 | 0 | 1 | 1 | N_ign + Tmse_PA | N_ign + Tmse_PA | 5, 12, 15 |
| | | | | | or T_TA*N* | |
| | | | | | (N_ign + Tmse_PA) | |
| 0 | 1 | 0 | 0 | — | — | 4, 6, 14, 15 |
| 0 | 1 | 0 | 1 | — | N_ign + Tmse_PA + 2seg | 4, 6, 14, 15 |
| | | | | | or T_TA*N* | |
| | | | | | (N_ign + Tmse_PA + 2seg) | |
| 0 | 1 | 1 | 0 | N_ign + Tmse_PA + 2seg | — | 4, 6, 14, 15 |
| 0 | 1 | 1 | 1 | N_ign + Tmse_PA + 2seg | N_ign + Tmse_PA + 2seg | 4, 6, 14, 15 |
| | | | | | or T_TA*N* | |
| | | | | | (N_ign + Tmse_PA + 2seg) | |
| 1 | 0 | 0 | 0 | — | — | 1, 2, 16 |
| 1 | 0 | 0 | 1 | — | T_PA*(N_ign + Tmse_CTF) | 1, 2, 16 |
| | | | | | or T_TA*N* | |
| | | | | | (T_PA*(N_ign + Tmse_CTF)) | |
| 1 | 0 | 1 | 0 | T_PA* | — | 1, 2, 3, 5, |
| | | | | (N_ign + Tmse_CTF) + N_ign + Tmse_PA | | 11, 16 |
| 1 | 0 | 1 | 1 | T_PA* | T_PA*(N_ign + Tmse_CTF) + N_ign + Tmse_PA | 1, 2, 3, 5, |
| | | | | (N_ign + Tmse_CTF) + N_ign + Tmse_PA | or T_TA*N* | 11, 16 |
| | | | | | [T_PA*(N_ign + Tmse_CTF) + N_ign + Tmse_PA] | |
| 1 | 1 | 0 | 0 | — | — | 1, 2, 3, 4, |
| | | | | | | 6, 13, 16 |
| 1 | 1 | 0 | 1 | — | T_PA*(N_ign + Tmse_CTF) + 2seg | 1, 2, 3, 4, |
| | | | | | or T_TA*N* | 6, 13, 16 |
| | | | | | (T_PA*(N_ign + Tmse_CTF) + 2seg) | |
| 1 | 1 | 1 | 0 | T_PA* | — | 1, 2, 3, 4, |
| | | | | (N_ign + Tmse_CTF) + N_ign + | | 6, 13, 16 |
| | | | | Tmse_PA + 2 seg | | |
| 1 | 1 | 1 | 1 | T_PA* | T_PA*(N_ign + Tmse_CTF) + N_ign + Tmse_PA + 2seg | 1, 2, 3, 4, |
| | | | | (N_ign + Tmse_CTF) + N_ign + | or T_TA*N* | 6, 13, 16 |
| | | | | Tmse_PA + 2seg | [T_PA*(N_ign + Tmse_CTF) + N_ign + Tmse_PA + 2seg] | |

The process commences (e.g., after a reset) at a start state 1202. In one embodiment, all hardware is kept in soft reset before programming the enables for each loop. When the soft reset is set, the loop coefficients may be frozen. Once the enables for the loops are programmed, the hardware will be released from soft reset.

In one embodiment, the loops that are to be enabled are defined before the reset state terminates. This limitation may serve to simplify how transitions are made between states. However, in this embodiment, the reset state is re-invoked whenever a given loop needs to be enabled or disabled after reset.

A given loop may be disabled for a variety of reasons. For example, a loop may be disabled to improve the performance of the receiver. In some circumstances where the length of the fiber is very long (e.g., 200 km), the PA loop may be disabled. In some circumstances where multiple loops (e.g., CTF and PA) are based on the same criteria (e.g., MSE), one or more loops may be disabled to prevent undesirable interactions between the loops.

Assuming the CTF loop is enabled, the process transitions to a CTF MSE measure state 1204 (path 16 enabled). At state 1204 an MSE measurement is taken for the current CTF coefficient setting. Before the MSE measurement is taken, however, the process delays a period of time to ensure that the DFE loop has converged. As discussed above, modification of some of the loop coefficients may result in the DFE converging to new values for the DFE coefficients. The process then collects MSE samples for a specified period of time. In one embodiment this process takes N_IGN+TMSE_CTF−10 clock cycles. Here, N_IGN defines a period of time sufficient to allow the DFE loop to converge (e.g., 10 cycles). TMSE_CTF−10 defines the number of cycles over which the MSE samples are taken. Accordingly, the TMSE_CTF value may be adjusted to speed up or slow down the CTF loop to provide a desired tradeoff between, for example, loop response and loop stability. The “−10” parameter relates to the time required for a CTF update discussed below. Accordingly, this parameter is factored in to simplify the loop calculation.

If the TA loop is enabled (en_ta), TA binning (e.g., collecting samples for the TA bins as discussed above) may be performed during the TMSE_CTF time period.

After the maximum count for state 1204 is reached the process transitions to a CTF update state 1206 (path 1 enabled). This state is 10 cycles long.

At the 10^{th} cycle, the process updates C_CTF (FIG. 1). As discussed above, this process involves comparing the MSE that was just measured at state 1204 with a prior MSE value and adjusting C_CTF in a manner that tends to reduce the measured MSE.

Also at state 1206, the process increments a counter (pa_win) for the PA loop. As discussed below this counter is used to determine when to enter the PA MSE measure state.

A TA update also may be performed at cycle 10 of state 1206. Here, the TA loop must be enabled and the PA loop disabled (˜en_pa) and the pa_win count is at a threshold value (T_PA). In one embodiment the conditions for a TA update may include: 1) at least one of bins 7, 8, 9 and 10 has at least a threshold number of hits (e.g., 512); 2) ta_win has reached the TA_bin threshold and bins 6, 7, 10 and 11 are larger than a threshold value; and 3) the TA loop is enabled. The rate at which pa_win reaches the threshold may be configurable. For example, the pa_win counter may count 1×, 8×, 16×, 32× of CTF(T_PA).

Also at state 1206, the process increments a counter (ta_win) for the TA loop provided that the TA loop is enabled and the PA loop is disabled. As discussed below this counter is used to determine when to enter the PA MSE measure state. The rate at which ta_win reaches a threshold may be configurable. For example, the ta_win counter may count 1×, 8×, 16×, 32× of PA(T_TA). Every TA update may reset this counter.

After the maximum count (10) for state 1206 is reached the process transitions back to the state 1204 when path 2 is enabled and (path 3 is disabled (˜Path 3) or (path 3 is enabled yet the pa_win counter does not equal the threshold value T_PA)). In this way the process may continue to measure the MSE for the CTF loop and update the CTF coefficients at states 1204 and 1206.

On the other hand, the process transitions to a PA MSE measure state 1208 when the count for state 1206 is 10, pa_win=T_PA and path 3 is enabled. In some embodiments the threshold T_PA is set to a value of 20. In this case, the PA loop may operate at a speed that is approximately 20 times slower than the CTF loop.

At state 1208 an MSE measurement is taken for the current PA coefficient setting. The process delays a period of time (N_IGN) before the MSE measurement is taken to ensure that the DFE loop has converged. The process then collects MSE samples for a specified period of time. In one embodiment this process takes N_IGN+TMSE_PA−10 clock cycles. Here, TMSE_PA−10 defines the number of cycles over which the MSE samples are taken. The “−10” parameter relates to the time required for a PA update discussed below. If the TA loop is enabled, TA binning may be performed during the TMSE_PA time period.

After the maximum count for state 1208 is reached the process transitions to either a PA update state 1206 (path 5 enabled) or an ADC state 1212 (path 4 enabled).

The PA update state 1210 is 10 cycles long. At the 10^{th} cycle, the process updates C_PA (FIG. 1). As discussed above, this process involves comparing the MSE that was just measured at state 1208 with a prior MSE value and adjusting C_PA in a manner that tends to reduce the measured MSE.

The process also increments the ta_win counter if the TA loop is enabled. In addition, a TA update also may be performed at the tenth cycle if the conditions for doing so are met and the TA loop is enabled. Thus, when the CTF and PA loops are both enabled, the TA updates are performed at the time of the PA update rather than at the time of the CTF update.

After the maximum count (10) for state 1210 is reached the process either transitions back to the PA MSE measure state 1208 (path 12 enabled) or transitions to the CTF MSE measure state 1204 (path 11 enabled).

The ADC state 1212 collects samples for each ADC setting. For example, in one embodiment the state lasts for N_SAMPLES_ADC*15 cycles. Here, N_SAMPLES_ADC is the number of sample collected for each ADC setting and 15 is the number of ADC settings (e.g., −7 to +7). After the maximum count for state 1212 is reached the process transitions to an ADC update state 1214 (path 6 enabled).

The ADC update state 1214 is 10 cycles long. At the 10^{th} cycle, the process updates C_ADC (FIG. 1). As discussed above, this process involves making relative error measurements and adjusting C_ADC in a manner that tends to reduce the measured relative error. In some embodiments provisions may be made to ensure that MSE is not measured when the ADC coefficients are being modified.

A PA update also may be performed at the tenth cycle if path 4 is enabled and the PA loop is enabled. Thus, when the ADC and PA loops are both enabled, the PA updates are performed at state 1214 rather than state 1210. In this embodiment, the PA update is performed at the same time as the ADC update. This speeds up the process since it may not be necessary to wait for the DFE coefficients to converge for every change of the PA coefficients and for every change of the ADC coefficients. It should be noted that the PA loop and the ADC loop depend on different criteria. Consequently, these loops may be configured with the same bandwidth without inducing instability to the loops.

In addition, a TA update may be performed at the tenth cycle if the conditions for doing so are met and the TA loop is enabled. Thus, when the ADC and PA loops are both enabled, the TA updates are performed at the time of the ADC update (state 1214).

The process also increments the ta_win counter if the TA loop is enabled. After the maximum count (10) for state 1214 is reached the process either transitions back to the CTF MSE measure state 1204 (path 13 enabled) or transitions back to the PA MSE measure state 1208 (path 14 enabled).

From the above, it should be observed that TA updates are performed at the same time as the updates for the CTF loop, the PA loop or the ADC loop. The specific time at which the TA is updated depends on which loops are enabled.

The two TA states 1216 and 1218 are used in the event the TA loop is enabled but the other loops are not enabled. The process transitions from the start state 1202 to the TA binning state 1216 when path 7 is enabled.

State 1216 involves the collection of the TA bin data for the TA tail distribution optimizer. The process delays a period of time (N_IGN) before the data is collected to ensure that the DFE loop has converged. The process then collects bin samples for a period of time. In one embodiment this process takes N_IGN+TMSE_PA−10 clock cycles. After the maximum count for state 1216 is reached the process transitions to a TA update state 1218 (path 8 enabled).

The TA update state 1218 is 10 cycles long. At the 10^{th} cycle, the process updates C_TA (FIG. 1) if the conditions for TA update are met. As discussed above, this process involves calculating the error associated with the y-intersect of lines defined by the TA bin data and adjusting C_TA in a manner that tends to reduce the calculated error. The process also increments the ta_win counter. After the maximum count (10) for state 1218 is reached the process transitions back to the TA binning state 1216 (path 10 enabled).

Referring again to Table 1, the fifth and sixth columns list the enable periods for the PA loop and the TA loop, respectively, for various loop combinations. In the table, the variable “N” in column 6 represents the number of times ta_win has to reset before bins 6, 7, 10 and 11 are larger than the TA_bin threshold. The term “2seg” refers to two segments where in one embodiment each segment comprises 1024 clock cycles.

Exemplary Optical Communication System

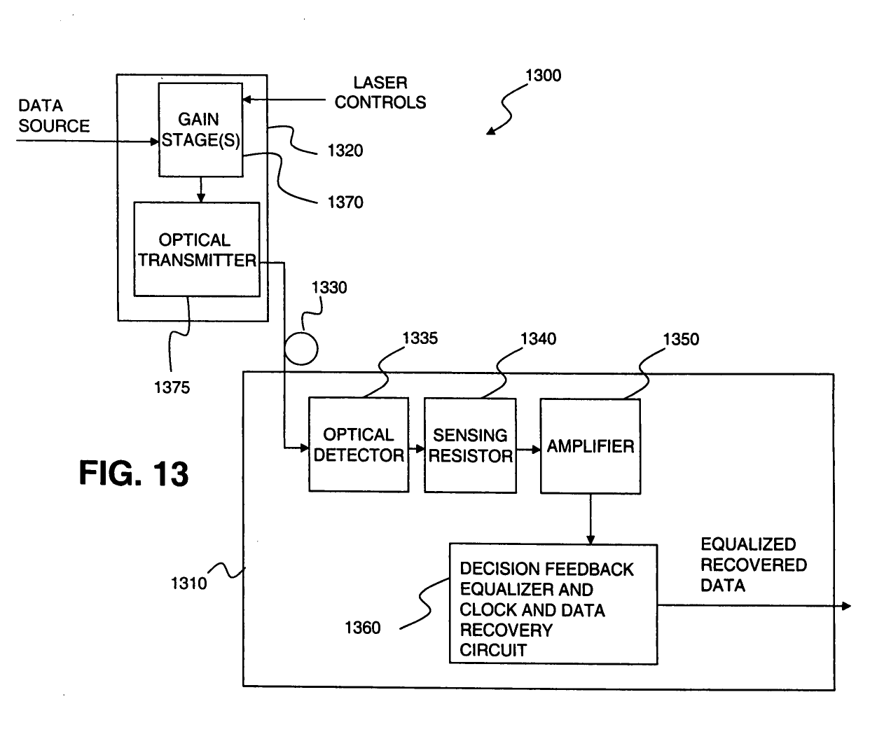

The teachings herein may be incorporated into a variety of applications. For example, referring to FIG. 13, the described circuits may be incorporated into an optical receiver assembly 1310 of an optical communication system 1300. The optical system 1300 includes an optical transmitter 1320 and an optical fiber network 1330 that carries the optical signal to the optical receiver assembly 1310. Those skilled in the art will appreciate that the present invention is not limited to a single optical transmitter and receiver. That is, optical communications systems may incorporate one or more optical transmitters as well as one or more optical receivers.

The illustrated receive path includes an optical detector 1335, sensing resistor 1340, one or more amplifiers 1350 and a decision feedback equalizer and clock and data recovery circuit 1360. The optical detector 1335 can be any known prior art optical detector. Such prior art detectors convert incoming optical signals into corresponding electrical output signals that can be electronically monitored.

A transmit path includes, by way of example, one or more gain stage(s) 1370 coupled to an optical transmitter 1375. In one embodiment an analog data source provides an analog data signal that modulates the output of the optical transmitter. In other embodiments baseband digital modulation or frequency modulation may be used. In this embodiment the gain stage(s) amplify the incoming data signal and the amplified data signal in turn drives the optical transmitter 1375.

The gain stage 1370 may have multiple stages, and may receive one or more control signals for controlling various different parameters of the output of the optical transmitter. The optical transmitter may, for example, be a light emitting diode or a surface emitting laser or an edge emitting laser that operates at high speeds such as 10 Gigabits per second (Gbps) or higher.

A receive fiber optic cable 1330 carries an optical data signal to the optical detector 1335. In operation, when the transmitted optical beam is incident on a light receiving surface area of the optical detector, electron-hole pairs are generated. A bias voltage applied across the device generates a flow of electric current having an intensity proportional to the intensity of the incident light. In one embodiment, this current flows through sensing resistor 1340, and generates a voltage.

The sensed voltage is amplified by the one or more amplifiers 1350 and the output of amplifier 1350 drives the decision feedback equalizer. As illustrated in FIG. 2, the decision feedback equalizer, includes, by way of example, a slicer that generates a binary signal (D) that drives the clock and data recovery circuit. The clock and data recovery circuit generates an extracted clock signal from the binary signal which is provided to a retimer (e.g., as illustrated in FIG. 3) to retime the equalized data.

It should be appreciated that the various components and features described herein may be incorporated in a system independently of the other components and features. For example, a system incorporating the teachings herein may include various combinations of these components and features. Thus, not all of the components and features described herein may be employed in every such system.

Different embodiments of the invention may include a variety of hardware and software processing components. In some embodiments of the invention, hardware components such as controllers, state machines and/or logic are used in a system constructed in accordance with the invention. In some embodiments code such as software or firmware executing on one or more processing devices may be used to implement one or more of the described operations.

Such components may be implemented on one or more integrated circuits. For example, in some embodiments several of these components may be combined within a single integrated circuit. In some embodiments some of the components may be implemented as a single integrated circuit. In some embodiments some components may be implemented as several integrated circuits.

The components and functions described herein may be connected/coupled in many different ways. The manner in which this is done may depend, in part, on whether the components are separated from the other components. In some embodiments some of the connections represented by the lead lines in the drawings may be in an integrated circuit, on a circuit board and/or over a backplane to other circuit boards. In some embodiments some of the connections represented by the lead lines in the drawings may comprise a data network, for example, a local network and/or a wide area network (e.g., the Internet).

The signals discussed herein may take several forms. For example, in some embodiments a signal may be an electrical signal transmitted over a wire while other signals may consist of light pulses transmitted over an optical fiber.

A signal may comprise more than one signal. For example, a signal may consist of a series of signals. Also, a differential signal comprises two complementary signals or some other combination of signals. In addition, a group of signals may be collectively referred to herein as a signal.

Signals as discussed herein also may take the form of data. For example, in some embodiments an application program may send a signal to another application program. Such a signal may be stored in a data memory.

The components and functions described herein may be connected/coupled directly or indirectly. Thus, in some embodiments there may or may not be intervening devices (e.g., buffers) between connected/coupled components.

A wide variety of devices may be used to implement the data memories discussed herein. For example, a data memory may comprise flash memory, one-time-programmable (OTP) memory or other types of data storage devices.

In summary, the invention described herein generally relates to an improved receive architecture. While certain exemplary embodiments have been described above in detail and shown in the accompanying drawings, it is to be understood that such embodiments are merely illustrative of and not restrictive of the broad invention. In particular, it should be recognized that the teachings of the invention apply to a wide variety of systems and processes. It will thus be recognized that various modifications may be made to the illustrated and other embodiments of the invention described above, without departing from the broad inventive scope thereof. In view of the above it will be understood that the invention is not limited to the particular embodiments or arrangements disclosed, but is rather intended to cover any changes, adaptations or modifications which are within the scope and spirit of the invention as defined by the appended claims.

What is claimed is:

1. A data communication system comprising:
an input for receiving a signal;
a first control loop configured to perform a square error calculation on data associated with the received signal and configured to adjust the received signal in accordance with the square error; and
a second control loop configured to optimize sampling of the data in accordance with a comparison of data from two different paths.

2. The system of claim 1 wherein the second control loop generates a relative error signal in accordance with the comparison.

3. The system of claim 1 wherein the data from two different paths comprises soft decision data and hard decision data.

4. The system of claim 1 wherein the data from two different paths comprises the data associated with the received signal and retimed equalized data.

5. The system of claim 1 wherein an accuracy of the comparison is independent of the square error.

6. A method of adjusting a received signal comprising:
receiving a signal;
sampling the received signal to generate data associated with the received signal;
performing a square error calculation in accordance with the data;
adjusting the received signal in accordance with the square error calculation; and
optimizing the sampling of the data in accordance with a comparison of data from two different paths.

7. The method of claim 6 comprising generating a relative error signal in accordance with the comparison.

8. The method of claim 6 wherein the data from two different paths comprises soft decision data and hard decision data.

9. The method of claim 6 wherein the data from two different paths comprises the data associated with the received signal and retimed equalized data.

10. The method of claim 6 wherein an accuracy of the comparison is independent of the square error.

11. A communications system comprising:
a decision feedback equalizer adapted to reduce channel related distortion in a received signal in accordance with a least mean square adaptation loop; and
a relative error adaptation loop adapted to optimize data for the least mean square adaptation loop in accordance with a comparison of data from two different data paths.

12. The system of claim 11 comprising a mean square error adaptation loop adapted to adjust the received signal.

13. The system of claim 12 comprising a continuous time filter for filtering the received signal in accordance with the mean square error adaptation loop.

14. The system of claim 12 comprising a phase adjust circuit for adjusting a phase of a clock recovered from the received signal in accordance with the mean square error adaptation loop.

15. The system of claim 12 comprising a threshold adjust loop adapted to adjust a DC component of the received signal in accordance with tail distribution data.

16. The system of claim 11 comprising a threshold adjust loop adapted to adjust a DC component of the received signal in accordance with tail distribution data.

17. The system of claim 11 comprising:
an analog to digital converter for digitizing a soft decision signal generated by the decision feedback equalizer to provide the data for the least mean square adaptation loop; and
a delay lock loop for generating a sampling clock for the analog to digital converter, wherein the relative error adaptation loop optimizes the sampling clock.

18. The system of claim 17 wherein the data from two different paths comprises the digitized soft decision signal and a hard decision signal.

19. A communications system comprising:
a mean square error adaptation loop configured to adjust a received signal in accordance with a mean square error adaptation loop; and
a relative error adaptation loop adapted to optimize data for the mean square error adaptation loop in accordance with a comparison of data from two different data paths.

20. The system of claim 19 wherein the mean square error adaptation loop comprises a continuous time filter for filtering the received signal.

21. The system of claim 19 wherein the mean square error adaptation loop comprises a phase adjust circuit for adjusting a phase of a clock recovered from the received signal.

22. The system of claim 19 comprising a threshold adjust loop adapted to adjust a DC component of the received signal in accordance with tail distribution data.

23. The system of claim 19 comprising:
an analog to digital converter for digitizing a soft decision signal generated by the decision feed back equalizer to provide the data for the mean square error adaptation loop; and
a delay lock loop for generating a sampling clock for the analog to digital converter, wherein the relative error adaptation loop optimizes the sampling clock.

24. The system of claim 23 wherein the data from two different paths comprises the digitized soft decision signal and a hard decision signal.

25. A communications system comprising:
a decision feedback equalizer adapted to reduce channel related distortion in a received signal in accordance with a least mean square adaptation loop; and
a threshold adjust loop adapted to adjust a DC component of the received signal in accordance with tail distribution data.

26. The system of claim 25 comprising a mean square error adaptation loop configured to adjust the received signal in accordance with a mean square error associated with the received signal.

27. The system of claim 26 wherein the mean square error adaptation loop comprises a continuous time filter for filtering the received signal.

28. The system of claim 26 wherein the mean square error adaptation loop comprises a phase adjust circuit for adjusting a phase of a clock recovered from the received signal.

29. A communications system comprising:
a mean square error adaptation loop configured to adjust a received signal in accordance with a mean square error associated with the received signal; and
a threshold adjust loop adapted to adjust a DC component of the received signal in accordance with tail distribution data.

30. The system of claim 29 wherein the mean square error adaptation loop comprises a continuous time filter for filtering the received signal.

31. The system of claim 29 wherein the mean square error adaptation loop comprises a phase adjust circuit for adjusting a phase of a clock recovered from the received signal.

32. A communications system comprising:
an automatic gain control circuit for amplifying a received signal;
a continuous time filter for filtering the amplified signal in accordance with a mean square error adaptation loop;
a decision feedback equalizer adapted to reduce channel related distortion in the filtered signal in accordance with a least mean square adaptation loop;
a clock and data recovery circuit adapted to recover a clock signal from the equalized signal;
a delay lock loop for generating a sampling clock for generating data for the adaptation loops; and
a relative error adaptation loop adapted to adjust a phase of the sampling clock in accordance with a comparison of data from two different data paths.

33. A communications system comprising:
an automatic gain control circuit for amplifying a received signal;
a continuous time filter for filtering the amplified signal in accordance with a mean square error adaptation loop
a threshold adjust loop adapted to adjust a DC component of the filtered signal in accordance with tail distribution data;
a decision feedback equalizer adapted to reduce channel related distortion in the threshold adjusted signal in accordance with a least mean square adaptation loop;
a clock and data recovery circuit adapted to recover a clock signal from the equalized signal; and
a delay lock loop for generating a sampling clock for generating data for the adaptation loops.

34. The system of claim 33 comprising a relative error adaptation loop adapted to adjust a phase of the sampling clock in accordance with a comparison of data from two different data paths.

35. The system of claim 33 comprising a phase adjust circuit for adjusting a phase of the clock signal in accordance with the mean square error adaptation loop.

36. The system of claim 33 comprising a search engine adapted to generate at least one initial coefficient for at least one of the adaptation loops.

37. A communication receiver comprising:
an automatic gain control circuit for amplifying a received signal;
a continuous time filter for filtering the amplified signal in accordance with at least one filter coefficient generated by at least one adaptation loop;
a threshold adjust loop adapted to adjust a DC component of the filtered signal in accordance with tail distribution data generated by the at least one adaptation loop;
a decision feedback equalizer adapted to reduce channel related distortion in the threshold adjusted signal, the decision feedback equalizer comprising:
a summer that combines the received signal with at least one equalized feedback signal generated by the at least one adaptation loop to generate a soft decision signal;
a slicer coupled to the summer, wherein the slicer converts the soft decision signal to a binary signal; and
a retimer coupled to the slicer, wherein the retimer generates detected data signals from the binary signal in response to an extracted clock signal;
a clock and data recovery circuit configured to generate the extracted clock signal from the binary signal and at least a portion of the detected data signals, the clock and data recovery circuit comprising a phase adjust circuit adapted to adjust a phase of the extracted clock signal in accordance with at least one phase coefficient generated by the at least one adaptation loop;
a delay lock loop for generating a sampling clock signal from the extracted clock signal;
a relative error adaptation loop adapted to adjust a phase of the sampling clock signal in accordance with a comparison of data from two different data paths; and
an analog to digital converter, clocked by the adjusted sampling clock signal, for sampling the soft decision signal to generate data for the at least one adaptation loop.

38. The system of claim 37 wherein the threshold adjust loop is coupled to receive the data from the analog to digital converter for generating the tail distribution data.

39. The system of claim 37 wherein the at least one adaptation loop comprises a least mean square loop coupled to receive the data from the analog to digital converter for generating the at least one equalized feedback signal.

40. The system of claim 37 wherein the at least one adaptation loop comprises at least one mean square error dithering loop.

41. The system of claim 40 wherein the at least one mean square error dithering loop is coupled to receive the data from the analog to digital converter for generating the at least one filter coefficient.

42. The system of claim 40 wherein the at least one mean square error dithering loop is coupled to receive the data from the analog to digital converter for generating the at least one phase coefficient.

43. The system of claim 37 wherein the data from two different paths comprises the data from the analog to digital converter and at least a portion of the detected data signals.

44. A method of providing a stable multiple loop system comprising:
providing a first adaptation loop based on a square error criteria; and
providing a second adaptation loop based on a tail distribution criteria.

45. The method of claim 44 wherein a converge time of the first adaptation loop is on the order of a converge time of the second adaptation loop.

46. The method of claim 44 wherein the square error criteria comprises a least mean square algorithm or a mean square error algorithm.

47. The method of claim 44 comprising providing a third adaptation loop based on the square error criteria, wherein a converge time of the first adaptation loop is at least an order of magnitude larger than a converge time of the third adaptation loop.

48. A method of providing a stable multiple loop system comprising:
providing a first adaptation loop based on a square error criteria; and
providing a second adaptation loop based on a relative error criteria.

49. The method of claim 48 wherein a converge time of the first adaptation loop is on the order of a converge time of the second adaptation loop.

50. The method of claim 48 wherein the square error criteria comprises a least mean square algorithm or a mean square error algorithm.

51. The method of claim 48 comprising providing a third adaptation loop based on the square error criteria, wherein a converge time of the first adaptation loop is at least an order of magnitude larger than a converge time of the third adaptation loop.
